(19) United States
(12) Patent Application Publication
(10) Pub. No.: US 2009/0120653 A1
(43) Pub. Date: May 14, 2009

(54) Fire suppression delivery system

(76) Inventor: Michael Steven Thomas, Bellerose, NY (US)

Correspondence Address: Michael S. Thomas, 254-03 86th Avenue, Bellerose, NY, 11426-2404, US

(21) Appl. No.: 11/349,785

(22) Filed: Feb. 7, 2006

Related U.S. Application Data
(63) Continuation-in-part of application No. 10/902,598, filed on Jul. 29, 2004.
(60) Provisional application No. 60/491,816, filed on Jul. 31, 2003.

(51) Int. Cl. A62C 37/10

(52) U.S. Cl. 169/61

(57) ABSTRACT

Within the Fire Suppression Delivery System, also referred to as The Fire Nemesis System™, Fire Nemesis System™, and Fire Nemesis™, the fire extinguishment encasements are modified to include a projectile airbrake to improve maneuverability; foam firefighting material encasement; and for direct application within marine vessels, including a sentinel encasement. The software security means of the System is enhanced to prevent unauthorized access to its data and software controlled functions. Two new adaptations of the Fire Nemesis System™, i.e., the Fourth and the Fifth Generation systems, were created. The Aerial Fire Suppression Drone is enhanced and includes a vertical flight design.

This application is a continuation-in-part Application of U.S. Ser. No. 10\902,598 (20050139363, herein referred to as “20050139363”) filed Jul. 29, 2004, which claims benefit of Provision Patent Application No. 60/491,816. The content of which is incorporated in its entirety into this application by reference.

All literature cited herein are incorporated in their entirety by reference into this Application.

### BACKGROUND OF THE INVENTION

This is a Fire Suppression Delivery System for the delivery of current, Next Generation, and future developments in the area of materials to extinguish, suppress or retard fires in, but not limited to high rise, commercial, industrial buildings; tunnel structures; offshore structures; oil and gas platforms; marine vessels; and environmental areas, also referred to as The Fire Nemesis System™, Fire Nemesis System™, and Fire Nemesis™.

The software security means of the Fire Nemesis System™ is central to the use of encrypted user data, to prevent access and by unauthorized persons. However, it is necessary to provide additional safeguards to the Fire Nemesis System™'s Soft Security System, so as to prevent unauthorized access to its software, and its software controlled systems and components.

The application of the Fire Nemesis System™ Fire Extinguishment Encasement is the ability to place fire extinguishment material directly within or effectively proximate to a fire, beyond the reach of conventional fire extinguishment and firefighting methods. Here, the first, second and third generation fire extinguishment encasement is improved to provide fire fighting foam discharge and enhanced maneuverability. Still further improvements are made, adapting the fire extinguishment encasement for application on board marine vessels, including a “sentinel fire extinguishment encasement” that serves as a survey vehicle.

The Fire Nemesis System™ Aerial Fire Suppression Drone is improved to permit operations proximate to and within an environmental fire zone: enhancing its exterior and interior insulation capacity; improved maneuverability by retraction of the tail rudder assembly and standard horizontal wing, while extending shorter canards; and. extending fire extinguishment type and load capacity.

### Additional Improvements

1. The Fire Nemesis System™ Software Security System

To those skilled in the art of software design and engineering, tampering with a program is the act of interfering with the function and operation of its intended design and purpose (U.S. Pat. No. 6,779,114). U.S. Pat. No. 6,779,114 (herein, “USPN”) also discusses at length the restrictions and inadequacies of predecessor software to prevent reverse engineering, copying, decompiling, tampering with or similar activities, and has proposed tamper resistant software-control flow encoding, which includes obscuration. Furthermore, software obscuration of codes such as at U.S. Pat. No. 6,694,435 may not necessarily protect the program from unauthorized decompiling, reverse engineering, copying, downloading, sequence tampering or similar acts.

The concern to be addressed here is not only access to and the theft of a program, its source code, but interference with the Fire Nemesis System™'s ability to recognize an authorized user's encrypted identifiers: thereby interfering with the Systems' operation, endangering lives and property, and resulting in identity theft.

Although U.S. Pat. No. 6,675,297 discusses increasing the difficulty of preventing reverse engineering, it does not discuss an alternative means to prevent such where initial or secondary attempts to access, decompile, reverse engineer, analyze, deconstruct, copy or similarly interfere with a software program and its source code have been overcome by an interloping system. Similarly, U.S. Pat. No. 6,675,297 does not discuss efforts to interfere with the function and operation of the interloping system: factors that are discussed by the current invention.

2. The Fire Nemesis System™s Binary Smart Fire Extinguishment Encasement

The advantages and use of foam for fire fighting is well documented within the industry (U.S. Pat. No. 6,109,359). However, to overcome the limitations in its application deep within an evolved fire, three concerns arise: maximizing of the foam creation ratio subsequent to mixing the foam material source and its fluid medium prior to dispersal to the environment; dispersal in such a manner that the foam bubble will not collapse before effective attachment to the fire area; and, the ability to project foam deep within a fire zone. Advances such as U.S. Pat. No. 6,276,459, U.S. Pat. No. 6,328,225 and U.S. Pat. No. 6,089,324, address the concern of maximizing the foam creation ratio and bubble integrity. Although U.S. Pat. No. 6,109,359 demonstrates the ability to project foam under pressure 70 to 100 feet, this alone will not address the demand to access an evolved fire beyond the projected reach of a handline, or beyond line-of-sight. To meet the three concerns expressed here, the Fire Nemesis System™'s fire extinguishment encasement system is modified for the projection and deployment of a foam fire fighting substance deep within a fire zone. Here, a binary encasement is designed to encapsulate and deliver the foam fire material source and its separated fluid mixing medium, which are mixed by command programming, and the foam creation ratio is significantly increased by injecting pressurized air or other gases into the foam mixture prior to its discharge from the encasement, through the ejection nozzle, to the environment.

3. The Fire Nemesis System™ Fire Extinguishment Encasement Projectile Airbrake

Methods for downrange projectile trajectory correction is an ever ongoing task, primarily shared by those skilled in the art of projectile design for military purposes, and more recently in the design of bullets. Smart munitions such as cruise missiles, have been fitted with devices which will adjust the trajectory for precision delivery to an intended target (Pre-Grant Application Number [herein “PGAN”] 20030037665) and can utilize a 2-D method of adjusting a projectile's trajectory for downrange correction. PGAN 20030037665 is designed to correct the flight of a projectile once it has left the barrel of its launching means. This invention and others, however, are not designed for maneuvering a projectile within close quarters or similar structures.

By integrating the fire extinguishment encasement's Global Positioning System with the accelerometers and gyroscopic means, known as an inertial measurement unit or “IMU”, (with or without a navigation equations processor), and MEMS or “micro electronic mechanical system” devices, such as those employed in the Guided Bullet (U.S. Pat. No. 6,474,593) it is possible the fire extinguishment encasement will overcome the shortcomings of using a Global Positioning System alone, when applied to combating fires within enclosed or semi-enclosed structures. Unlike the Lipeles guided bullet (U.S. Pat. No. 6,474,593) which must have a static target, the current invention has the capacity to find its target by its own devices, enroute to or proximate to the target area, while permitting continued deployment of its trajectory correction surfaces to fine tune its search and targeting parameters.

4. The Fire Nemesis System™ Aerial Fire Suppression Drone

To those skilled in the art and use of high quality insulation, such as the insulation applied to the surface of the space shuttle orbiter, the application of same to the exterior of the Fire Nemesis System™ Aerial Fire Suppression Drone (or similar aircraft) renders the aircraft viable for operations directly within a fire zone. U.S. Pat. No. 6,866,733 discusses recent developments in the manufacture of surface insulation that will withstand exposure to surface temperatures of 2,300° F. upon reentry of reusable launch vehicles (“RLV”) to earth's atmosphere. It also discusses the application of high quality insulation to the interior of a RLV as a shield against extreme heat, while U.S. Pat. Nos. 6,722,611 and 6,612,217 look at strengthening or hardening of the fuselage to prevent penetration by a projectile, without significantly increasing an aircraft's weight. The application of the aforementioned technology to the exterior fuselage and the interior chamber of the Fire Nemesis System™'s Aerial Fire Suppression Drone or similar aircraft) will allow the latter to operate directly within a fire zone, while protecting its components, operating systems, and the aircraft itself from the ravages of extreme heat that would otherwise compromise the use of vehicles operating within the same zone.

The use of S/TOL and V/TOL technology for use in military aircraft is well established. The operation of a VTOL aircraft within a fire zone, such as a forest fire, has several problems: exposure of the rotary blades and the tail rotor to trees and projectile debris common to the fire zone; limited maneuverability within a densely populated fire zone; large downwash footprint which could fan flames, causing a greater conflagration; and, instability within the thermal updraft of the fire, to suggest just a few. The function of horizontal flight aircraft is limited in the ability to hover. Although horizontal flight speed is greater than a VTOL vehicle such as a helicopter, coupling same with a VTOL system increases weight and requires considerable power to achieve significant altitude and forward momentum to sustain horizontal flight by fuselage or wing mounted engines. As well, the standard wingspan of a horizontal flight aircraft becomes prohibitive factor for aircraft operation directly within a fire zone.

Operating a ramjet type engine within or proximate to a fire zone has several limitations: e.g., airborne particulate matter clogging of intakes, penetration by fire related projectiles, inadequate fuel/air mixture related to oxygen depletion in a fully evolved fire. Power generation systems such as the Solid Oxygen Regenerative Fuel Cell, U.S. Pat. No. 6,854,688 may present a viable alternative. Ducted rotary fan engines traditionally transition well to the high speed forward motion of a standard horizontal flight aircraft, however, it does protect the turbofan from projectile debris: and, its gas/fluid stream can be directed through openings in the fuselage or wing to produce the vertical lift and hover capacity required for operation of the aircraft within the fire zone. Thrust vectoring of an aircraft's engine exhaust to improve maneuverability and thrust is well known to those skilled in the art of military aircraft design (U.S. Pat. Nos. 6,938,408, 6,382,559 and 6,298,658). Until recent developments the number of moving parts involved and the increase in aircraft weight, thrust vectoring which was not given strong consideration for use in unmanned, commercial, or passenger aircraft is given direct application here.

To overcome these limitations in the use of aircraft to combat fires, the Fire Nemesis System™ Aerial Fire Suppression Drone is fitted with ducted propulsion means: with its exhaust channeled through ports throughout the fuselage, each equipped with thrust vectoring vanes. Fitting the exterior fuselage with high quality insulation as used in RLVs, and penetration resistant skin, will support operation of the Fire Nemesis System™ Aerial Fire Suppression Drone within the fire zone. Affixing the interior chamber of the aircraft with high quality insulation or reusable insulation and backfilling the space between the fuselage and the interior chamber with an inert gas to reduce infiltration of heat, should also absorb impact to the fuselage. By sweeping a shorter horizontal flight wing assembly into the fuselage for hover or VTOL operations within a fire zone and the use of limited propulsion mean's exhaust through thrust-vectored ports vented through the fuselage, along with the deployment of at least two shorter, moveable wings or canards should provide stabilization during operations within a fire zone. The current invention also explores harvesting the thermal energy generated by the fire zone to operate a power generation means, which in turn can power the ducted/turbofan system.

The Vertical Flight Fire Suppression Delivery System is primarily designed for but not limited to vertical flight operations within a structural fire zone, as well as an environmental fire zone. Here, a turbine engine system is enclosed within the fuselage, as opposed to the use of an exposed rotary blade found with helicopter and turboprop engine aircraft. The latter have greater exposure to debris and require a greater operating radius and control to prevent striking a surface that can cause damage to the blade or nacelles, the structure, and endanger lives. This design will reduce the overall vertical height of the vehicle. By incorporating a positive ballast system for use while the vehicle is in an operational mode, and retractable landing gear or stanchions, the vehicle can maintain a positive vertical position during flight and pre-flight operations. By optionally equipping the vehicle with at least two propulsion means provides a safeguard in the event that one propulsion system fails, such enhances stabilization, maneuverability and control. By equipping the vehicle with the scanning means cited throughout the development of the Fire Nemesis System™, this vehicle can then provide to firefighters monitoring and combating the fire a live scan and monitoring feed from within the heart of a fire situation.

5. The Fire Nemesis System™s Fourth Generation Fire Suppression Delivery System

The growth of smart or intelligent building systems has become exponential during the past decade. The ability of a scanning means to differentiate the thermal spectrum discussed at U.S. Pat. No. 6,507,023, and the charge-coupled semiconductor device and complimentary metal oxide semiconductor devices in a smart camera system, when linked to systems known to those skilled in the are of smart or intelligent building systems (U.S. Pat. No. 6,873,256) will provide early fire detection and reporting, with a live feed to observe a fire's progression, thereby permitting remote access to the fire zone by observers. U.S. Pat. No. 6,819,237 discusses a number of sensors, active and passive fire detection and scanning methods, including the detection and reporting of persons within or near the target area.

While U.S. Pat. No. 6,873,256 discusses the use of strategically placed GPS-linked sensors as its means of fire detection, video to display the place of a flame, and a 3-D floor plan display with a skeletal perspective of a building contained within its database, it does not address the concern of realignment of the system when its scanning means is dislodged from its original position by a fire, blast or other unintended means: thus, compromising the use of data generated. U.S. Pat. No. 6,873,256 is further limited by its inability to provide spectrum or thermal differentiation data and analysis.

With live data provided by the Fire Nemesis System™'s Smart Building Fire Suppression System from within the target structure or fire zone to the Fire Nemesis System™'s Smart Fire Extinguishment Encasement's programming means, the System's operator can identify the target position of interest, tap that location wherein the location data is integrated with the stored target area data and utilized by the programming means to determine the trajectory, potential launch positions, targeting, tracking, search strictures and discharge parameters.

6. The Fire Nemesis System™'s Fifth Generation Fire Suppression Delivery System

Marine fire protection systems are quite often an adaptation of, their land based static fire safety system counterparts: where total flooding of a compartmental fire zone is accomplished by streaming a fire extinguishment medium, fed through nozzles supplied, by lines connected to a pressurized fire suppression material containment means. Similarly, marine systems face the same problems as their land based counterparts where the connection between the containment means and final ejectment to the fire environment is severed or otherwise compromised, resulting in attenuated or nonexistent fire suppressant flow. To overcome this concern the Fire Nemesis System™'s Fifth Generation Fire Suppression Delivery System is developed for both static, self-contained deployment of fire extinguishment encasements, and handheld launching of same to and within a marine vessel compartment. Here, the Fire Nemesis System™ specifically adapted for application on board marine (military, commercial and recreational) vessels with personnel accessible compartments and access-ways, where fire and/or blast has occurred.

### SUMMARY OF THE INVENTION

It is one object of this invention to provide additional means of safety to protect the use of encrypted and non-encrypted data, software programs and software controlled components utilized by the Fire Nemesis System™. The intent and purpose of having an encryption means here is to safeguard authorized user data, so as to prevent unauthorized access to and operation of the electronic and smart technology systems. In light of growing technology, such safeguards may be rendered meaningless where unauthorized persons are able to access, manipulate and for other purposes utilize or interferes with the encrypted identification (e.g., fingerprint or other suitable means of individualized biostat or biosensory) data through such avenues as reverse engineering, decompiling, tampering with, copying, downloading or similar means. Unauthorized access and use of encrypted identification data is, in short, identity theft.

To overcome this concern, additional software or program safety features are envisioned, including software codes to prevent reverse engineering, copying, downloading, decompiling, tampering with or similar activities. As an additional measure to safeguard the System, where unauthorized access results in overriding the primary anti-reverse engineering code and the System's next security level, then multiple, embedded, independent, security measures are proposed. The multiple, independent, embedded, security measures are redundant programs designed to prevent unauthorized overriding of the entire system by an unauthorized entity bypassing one or two levels of the anti-reverse engineering access means. When triggered, the multiple, embedded, security measures will convert all encrypted data to an irreversible, single negative or positive code format; systematically set in motion destruction of the software and memory systems; upload to the unauthorized user's computer and electronic means used for such access codes that will ultimately shut down and render the latter useless; and, prevent decompilation of the software program that caused it to shut down.

A second objective of this invention is to develop a Fire Nemesis System™'s binary Smart Fire Extinguishment Encasement that will deliver and effectively deploy a foam firefighting agent.

A third objective of this invention is to improve the maneuverability of the Fire Nemesis System™ Smart Fire Extinguishment Encasement, by incorporating one or more airbrakes to increase drag. In a preferred embodiment, when the control means of the airbrake system that is linked to the encasement's trajectory, search, and discharge controls is activated to deploy one or more of the airbrakes to the external surface, the trajectory's turning radius and speed can be reduced.

A fourth objective of this invention is to enhance operations of the Fire Nemesis System™ Aerial Fire Suppression Drone and other aircraft employed for firefighting purposes, by including high quality insulation, to its exterior and interior surfaces, to provide protection against exposure to the extreme heat environment of a fire; enclosed rotary, turbofan engines for hovering and closer maneuverability within the fire zone, with shrouds or ducts for protection against debris common to fire zones; the installation of 180° vertical high-speed fire extinguishment jets; the employment of mid air refueling and fire extinguishment replenishment means, and docking collars to facilitate attachment to a host aircraft for transport and deployment purposes, refueling and replenishment; exterior fuselage and interior chamber strengthening to withstand the impact of debris common to (environmental) fire zones. By incorporating an alternative power generation means for operation in low oxygen level environments the aircraft will not be compromised by airborne fire related particles, the fouling of air intakes, or oxygen depletion created by the fire, and/or the effective use of fire extinguishments; exhaust vectoring to increase thrust and improve maneuverability; fuselage retraction of the tail rudder assembly and the horizontal flight wing, along with the extension of multiple shorter stabilizing wings will increase aircraft stability for in-fire zone operations. By vertically ringing the fuselage's exterior with (high pressure) fire extinguishment or encasement ejectors, incorporating fire extinguishment containment means with a load capacity up to 5,000^{+psi} or 10,000^{+psi}, and equipped with a vibration means to prevent clogging and freezing within the extinguishment holding means and connecting lines, pumps, and ejection ports, such will enhance deployment of (powder, granular or similar) fire extinguishments to the environment. It is further the objective of this invention to develop a modified Fire Nemesis System™ Aerial Fire Suppression Drone or similar aircraft primarily for but not limited to vertical flight operations within a structural fire zone, as well as an environmental fire zone.

A fifth objective of this invention is to develop a smart building fire detection and scanning system that can be directly linked to the scanning capabilities discussed in the Fire Nemesis System™: that will operate from within the target structure and the fire itself. By integrating real time scan data achieved by the smart building scanning means with the Second and Third Generation systems of the Fire Nemesis System™, firefighters can look at the fire from a view within the fire zone itself, with an enhanced ability to program the smart encasement for fire extinguishment of the area.

A sixth objective of this invention is to adapt the Fire Nemesis System™ for application aboard commercial (including passenger or cruise) and military vessels. The Fire Nemesis System™'s Third and Fourth generation Smart Fire Extinguishment Encasement is further modified to include a Fire Suppression Delivery System Sentinel Smart Fire Extinguishment Encasement, to scan a vessel's compartment and a fire's topography, and then transmit that data for Fire Nemesis System™ Smart Fire Extinguishment Encasement programming. A blast proof containment means of the Fire Nemesis System™'s Fifth Generation Marine Vessel Containment system is developed as a compartment installed self-contained system. The Fire Nemesis System™'s Fifth Generation Marine Vessel Containment system will include database modifications specific to marine vessels and the compartment housing same, along with modifications of the hand held fire extinguishment encasement launcher.

### DETAILED DESCRIPTION OF THE FIGURES

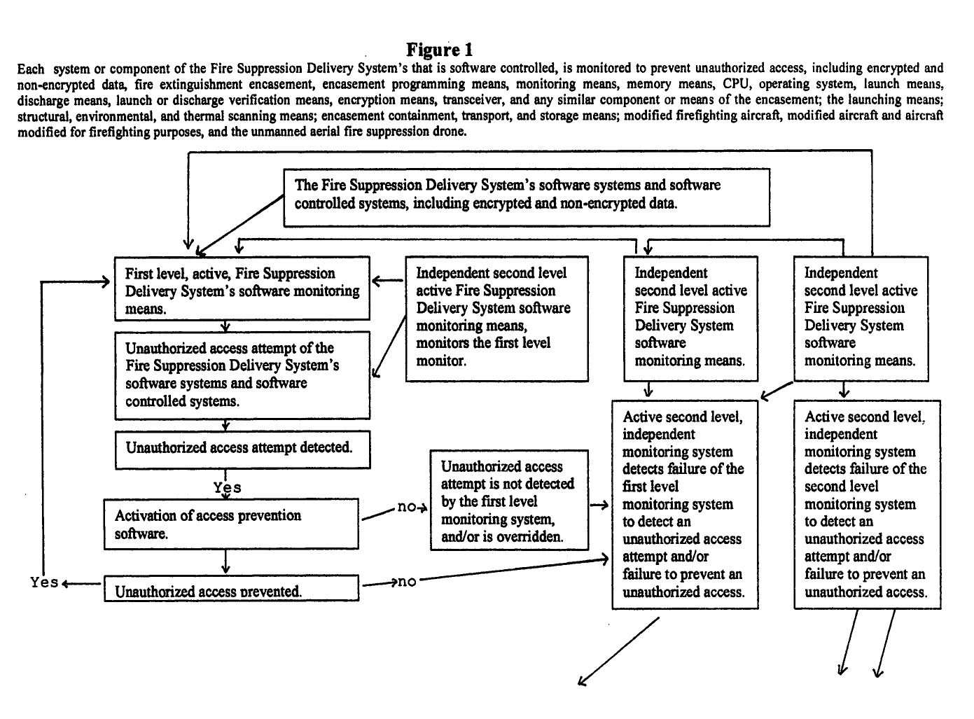

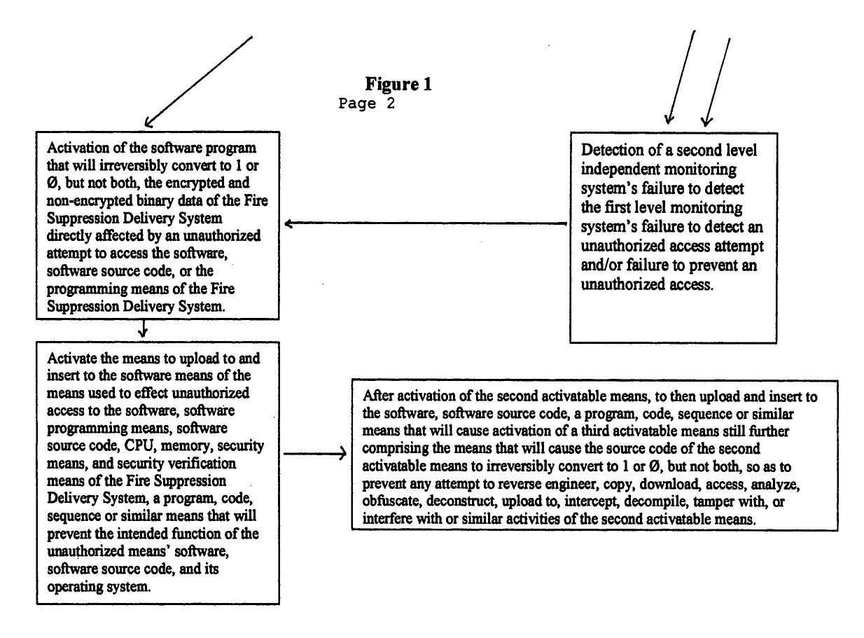

FIG. 1 is a block diagram of the Fire Nemesis System™'s Software Security means illustrating the first and second level: an independent software security systems that continually monitors the Fire Nemesis System™ to detect and prevent an unauthorized attempt in any manner to access, reverse engineer, modify, corrupt, interfere with, decompile, tamper with or otherwise to enter, copy, download, upload to, insert, analyze, deconstruct, remove or otherwise to determine the data, encrypted data, non-encrypted data, code, codes, code sequences, source code, operating codes, operating sequence(s), operating code sequence(s), operating means, software operating means of the Fire Nemesis System™'s software controlled systems and components.

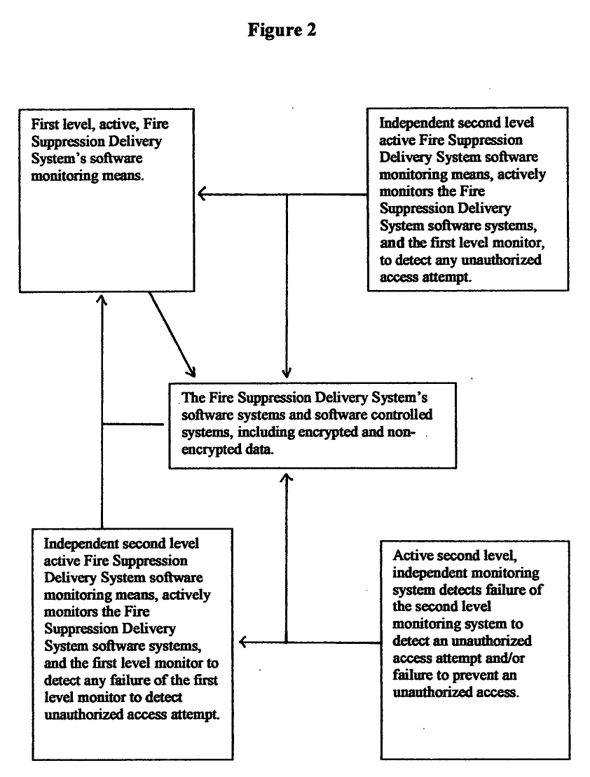

FIG. 2 is a block diagram of the Fire Nemesis System™'s Software Security means illustrating the monitoring interrelation between the Fire Nemesis System™'s software controlled systems, components, and the First and Second Level Monitor.

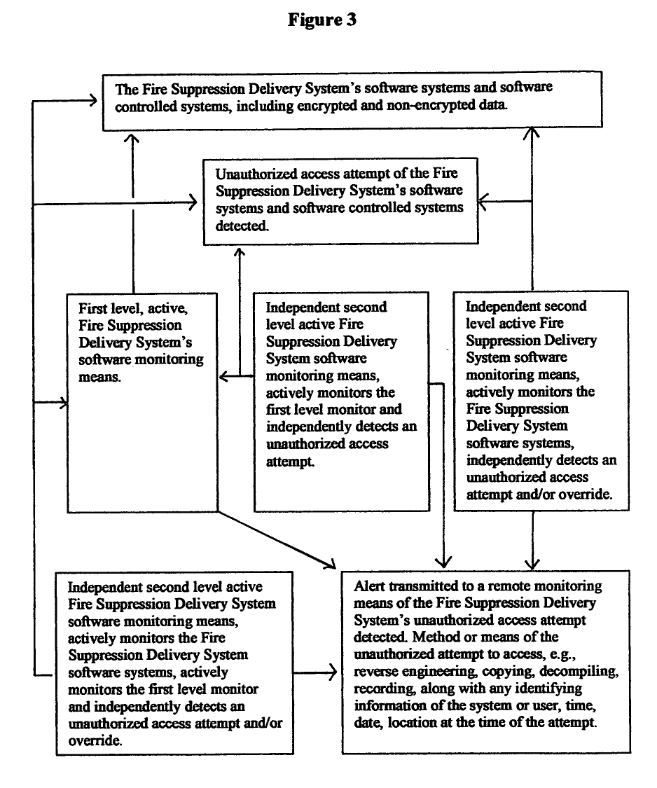

FIG. 3 is a block diagram of the Fire Suppression Delivery System (herein, “System”) Software Security means where an unauthorized attempt to access the Fire Nemesis System™'s software controlled system and components is detected, thereafter activating the means to transmit an alarm to the Fire Nemesis System™'s remote monitoring system, including such information as the last known or recorded GPS setting, last known or recorded MEMS setting, time, date, location, and software information identifying the intruding system.

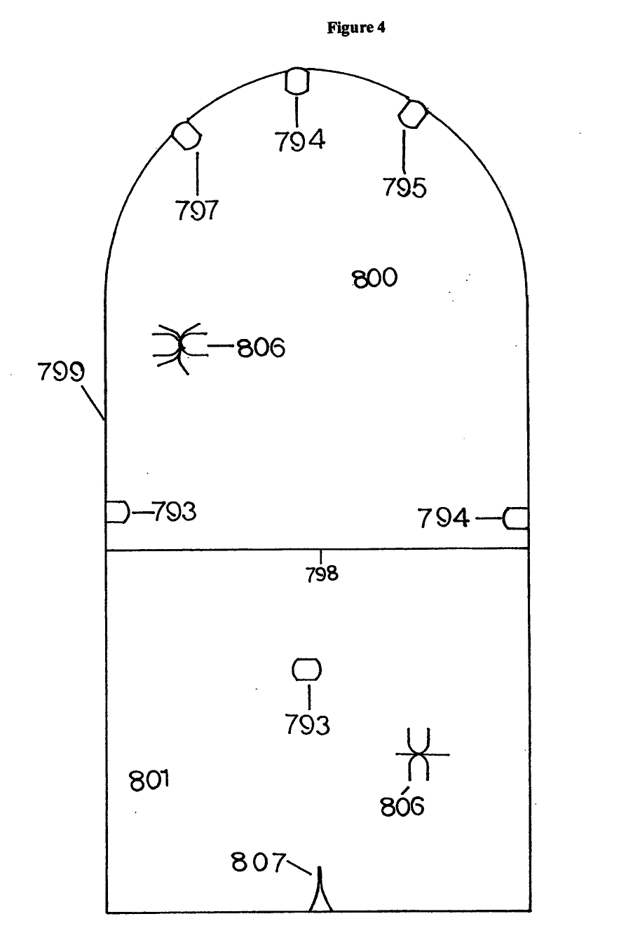

FIG. 4 illustrates the binary, foam firefighting, Fire Nemesis System™ Smart Fire Extinguishment Encasement with a bifurcated separation means, for separate containment of the foam material source and its fluid accelerator.

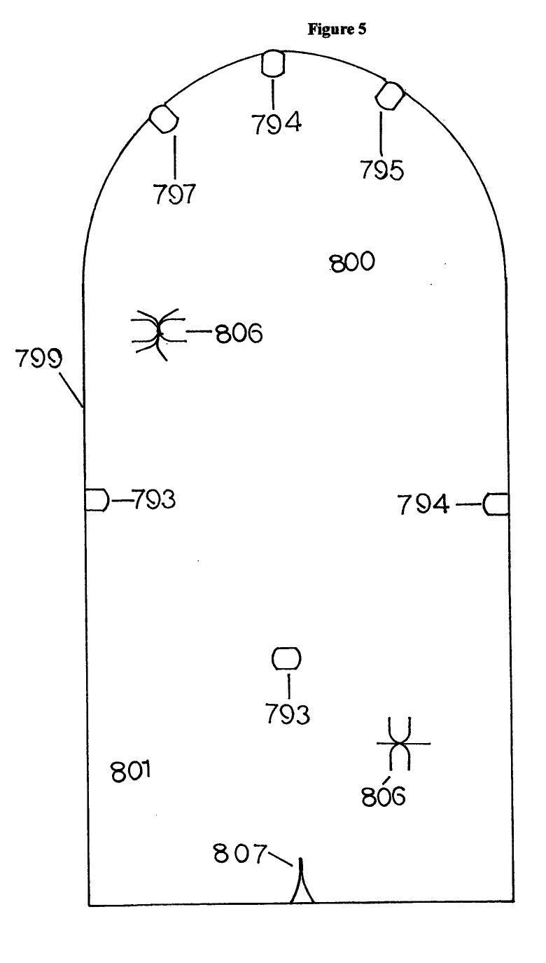

FIG. 5 illustrates the binary, foam firefighting, Fire Nemesis System™ Smart Fire Extinguishment Encasement, where the separating barrier is intentionally compromised to facilitate mixing of the foam material source and its fluid accelerator.

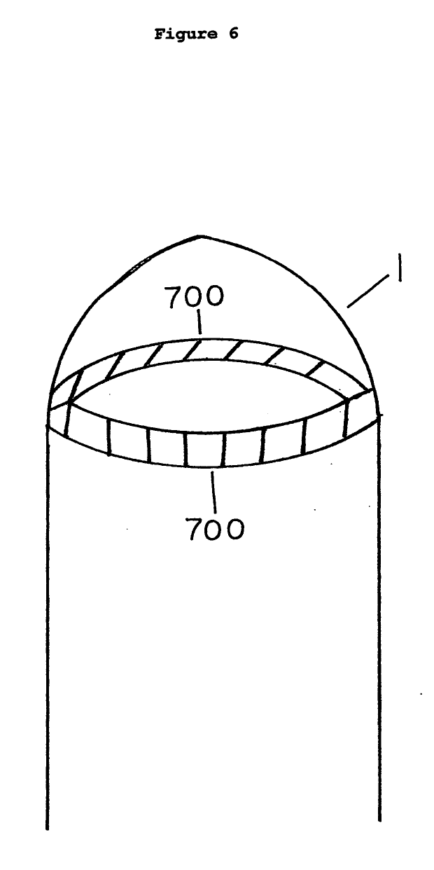

FIG. 6 is an illustration of the projectile braking means contained within the Fire Nemesis System™'s Fire Extinguishment Encasement.

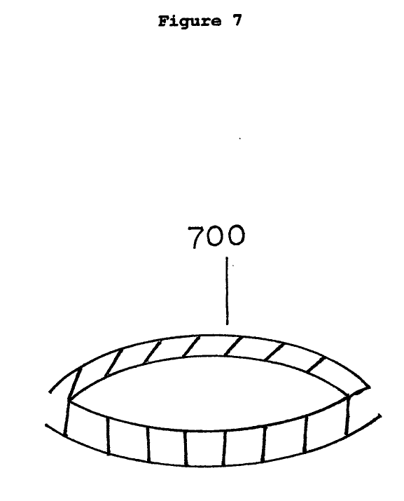

FIG. 7 is an illustration of the projectile braking means shown independent of the Fire Suppression Delivery System Fire Extinguishment Encasement.

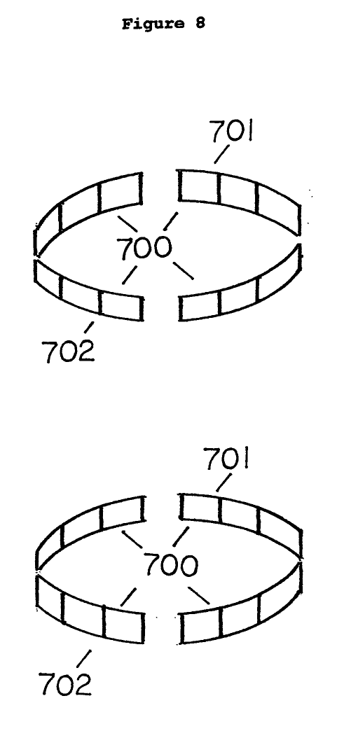

FIG. 8 is an illustration of ganged series of projectile braking means shown independent of the Fire Nemesis System™ Fire Extinguishment Encasement.

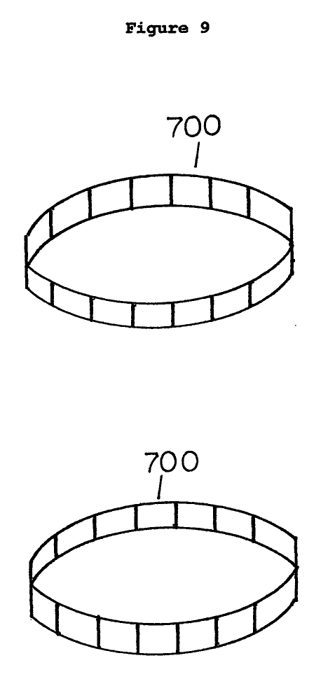

FIG. 9 is an illustration of the dual or fore and aft positioned series of projectile braking means shown independent of the of the Fire Nemesis System™'s Fire Extinguishment Encasement.

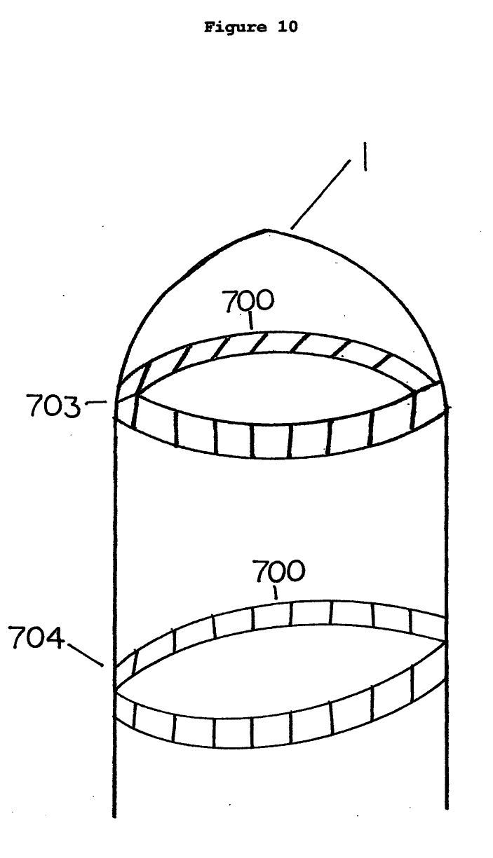

FIG. 10 is an illustration of the dual, fore and aft positioned series of projectile braking means contained within the Fire Nemesis System™'s Fire Extinguishment Encasement.

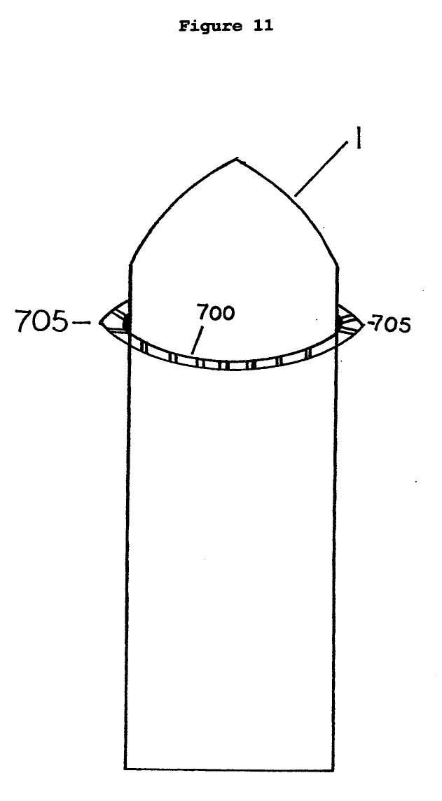

FIG. 11 is an illustration of the projectile braking means deployed to the exterior of the Fire Nemesis System™'s Fire Extinguishment Encasement.

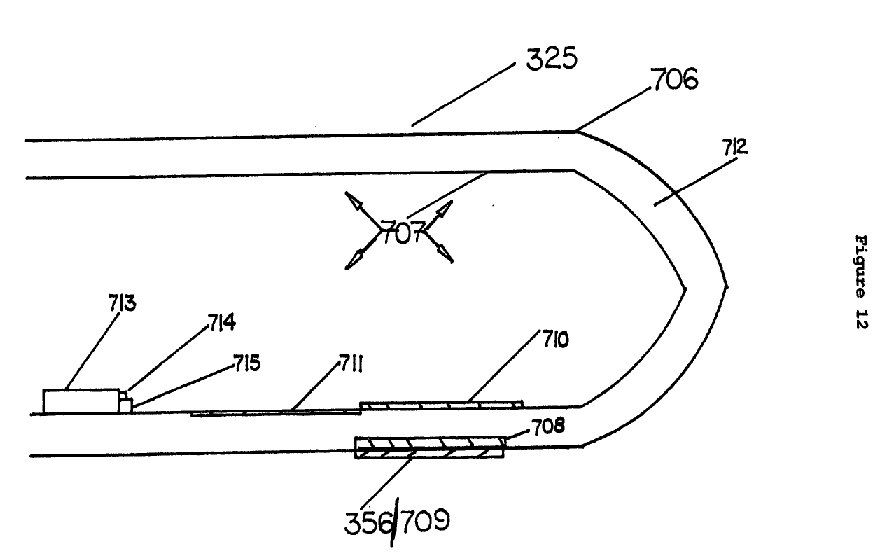

FIG. 12 is an illustration of the Fire Nemesis System™ Aerial Fire Suppression Drone, where the exterior and interior surface of the fuselage are fitted with high quality insulation; insulation to the interior surfaces of the interior chambers/compartments. The interior space between the fuselage and component chamber is backfilled with an inert gas linked to the containment and pumping means.

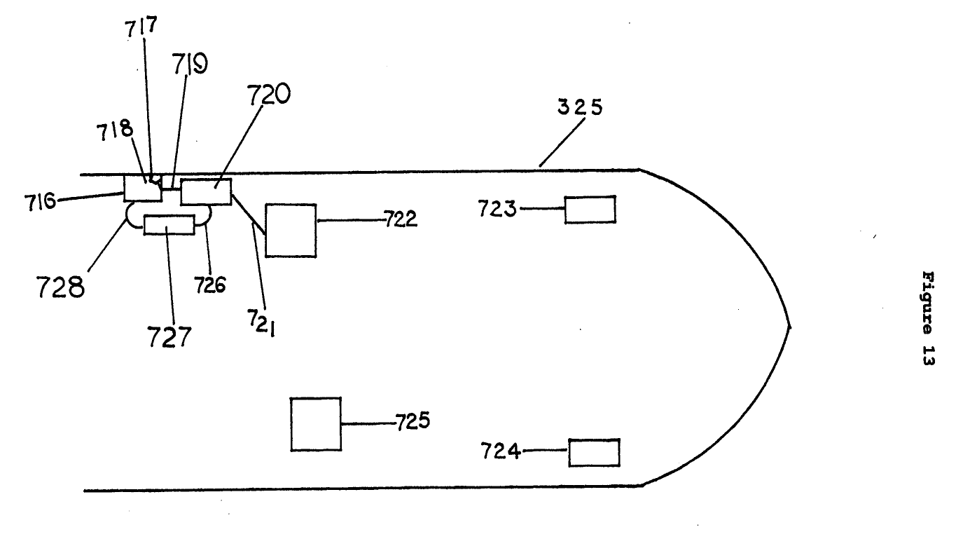

FIG. 13 illustrates a Fire Nemesis System™ Aerial Fire Suppression Drone where the thermal capture unit will superheat a working fluid or gas. This superheated medium will be pumped to the power generation means to generate power necessary for transfer to and operation of the propulsion means (an alternate propulsion means).

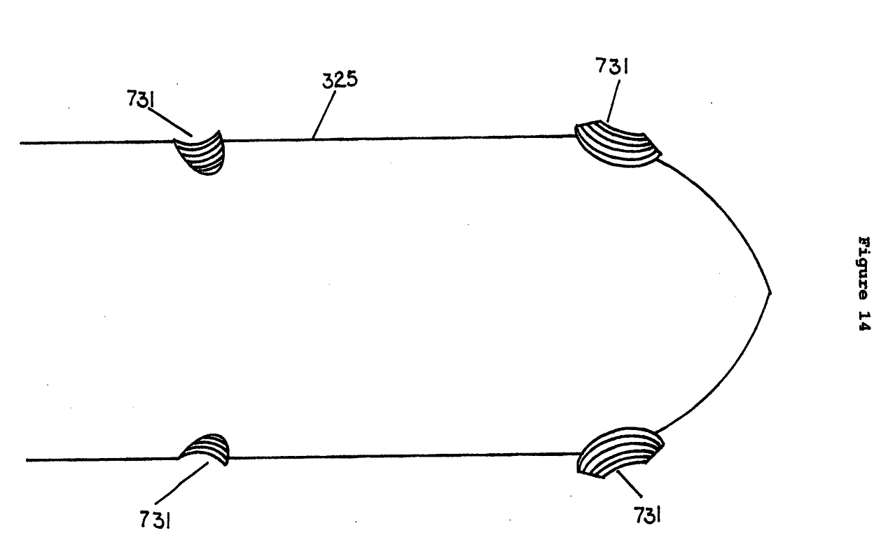

FIG. 14 illustrates exhaust ports (731) strategically placed throughout the fuselage of the Fire Nemesis System™ Aerial Fire Suppression Drone, with thrust vectoring means to provide lift required to sustain vertical flight/hovering of the aircraft.

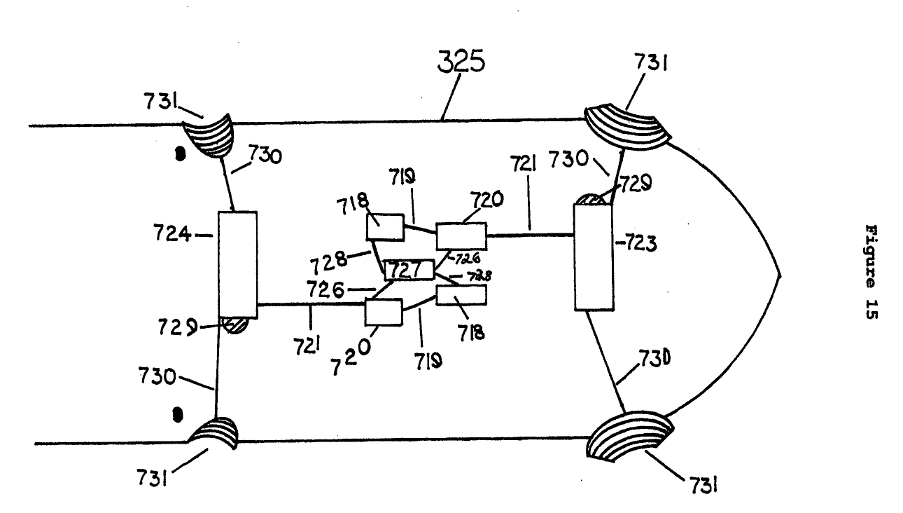

FIG. 15 illustrates dual thermal capture units that are centralized within the Fire Nemesis System™ Aerial Fire Suppression Drone's fuselage (for load distribution purposes) and dual semi/enclosed propulsion means placed fore and aft. A heat exchanger is attached to the propulsion means to prevent heat buildup within the fuselage, the propulsion means and the containment area.

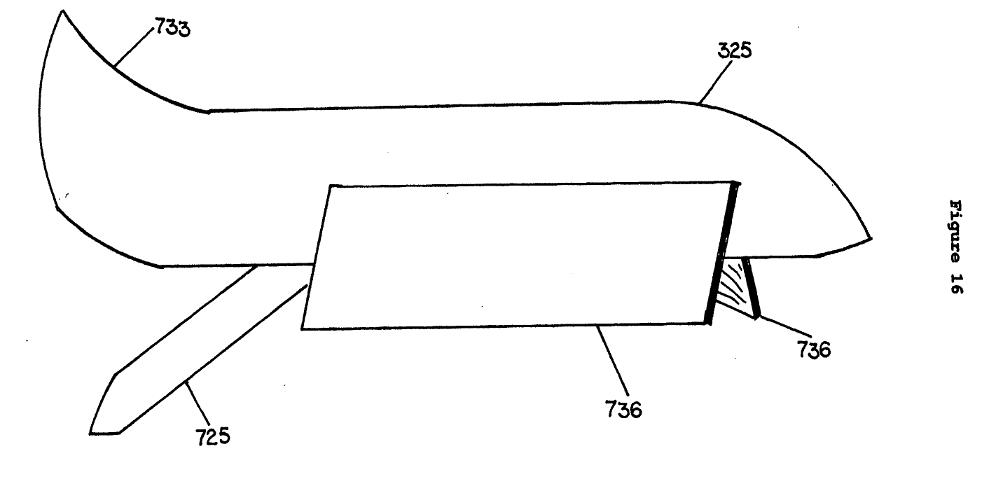

FIG. 16 illustrates a limited vertical view of the Fire Nemesis System™ Aerial Fire Suppression Drone, its horizontal flight wing deployed from the aft or underside of the aircraft, and the tail rudder assembly fully extended for horizontal flight.

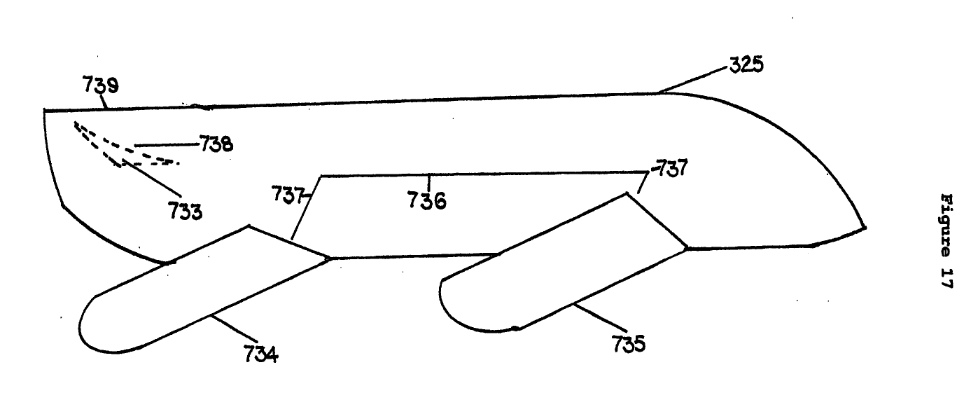

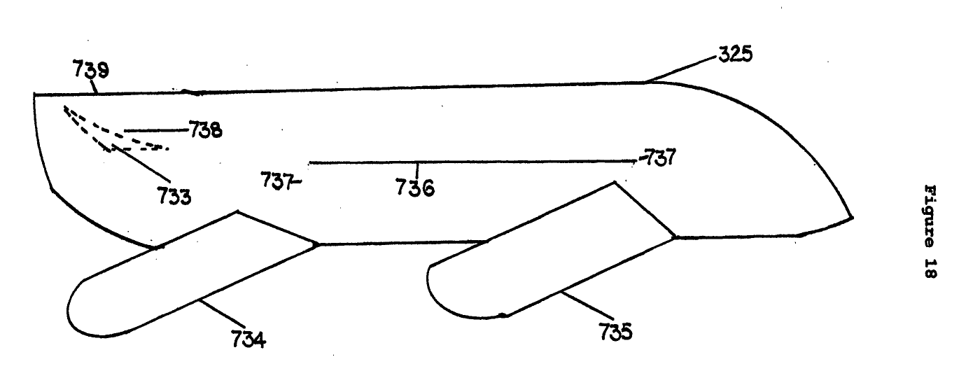

FIG. 17 and FIG. 18 illustrate full deployment of the Fire Nemesis System™ Aerial Fire Suppression Drone's shorter stabilizing wings (or, canards). Here the horizontal flight wing is retracted and housed behind the protective fuselage doors, and the tail rudder assembly is retracted into the tail assembly area of the fuselage.

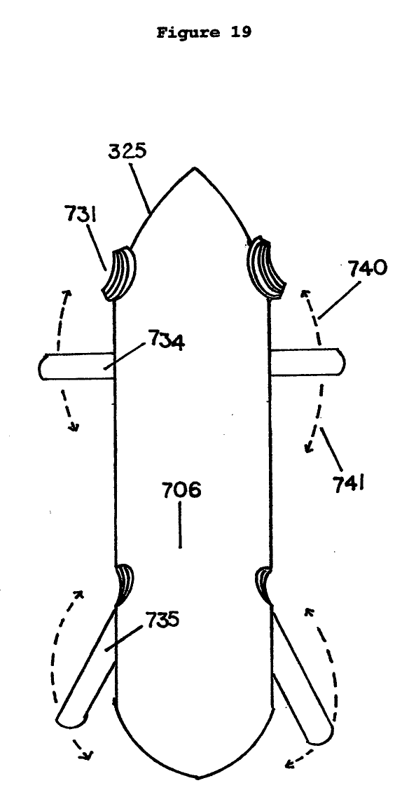

FIG. 19 illustrates a limited horizontal view of the fuselage where the shorter stabilizing wings are fully deployed (which can be moved in a horizontal arch): combined with its thrust vectoring capacity to effect optimal hovering and stabilization of the aircraft.

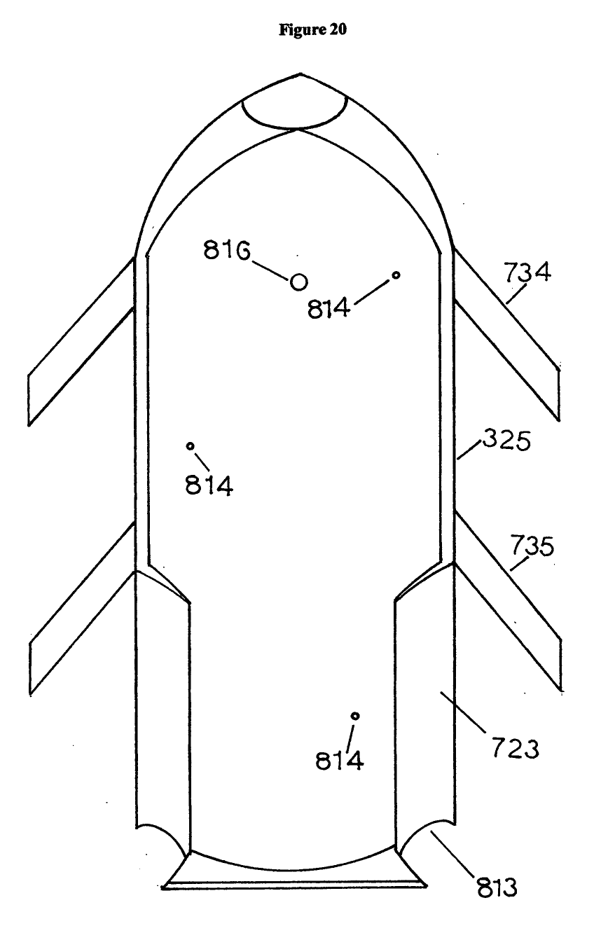

FIG. 20 illustrates the Fire Nemesis System™ Aerial Fire Suppression Drone modified primarily for vertical flight operations within structural and environmental fire zones.

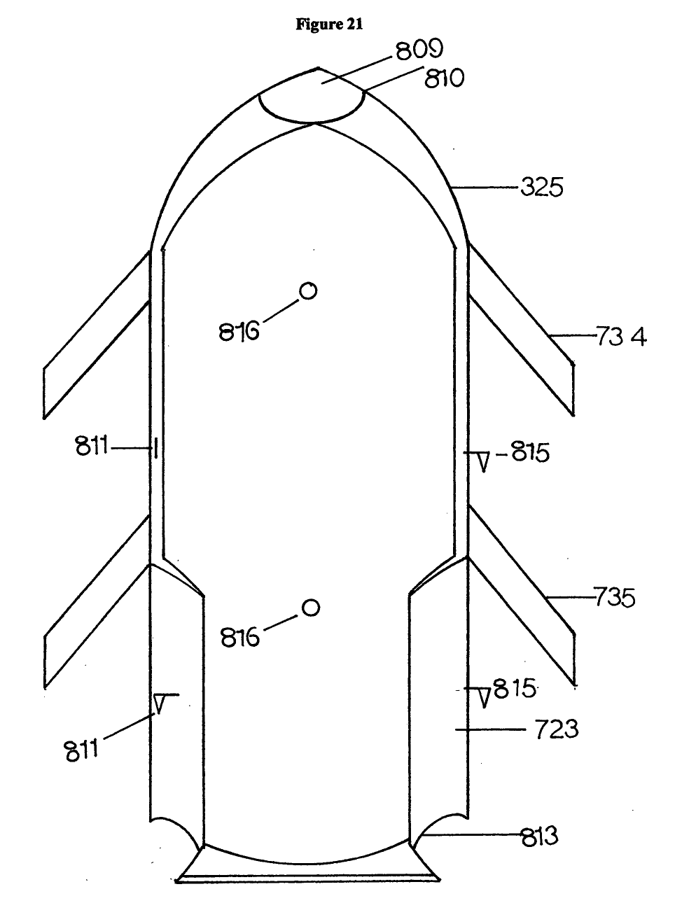

FIG. 21 illustrates the Fire Nemesis System™ Aerial Fire Suppression Drone modified primarily for vertical flight operations within structural and environmental fire zones.

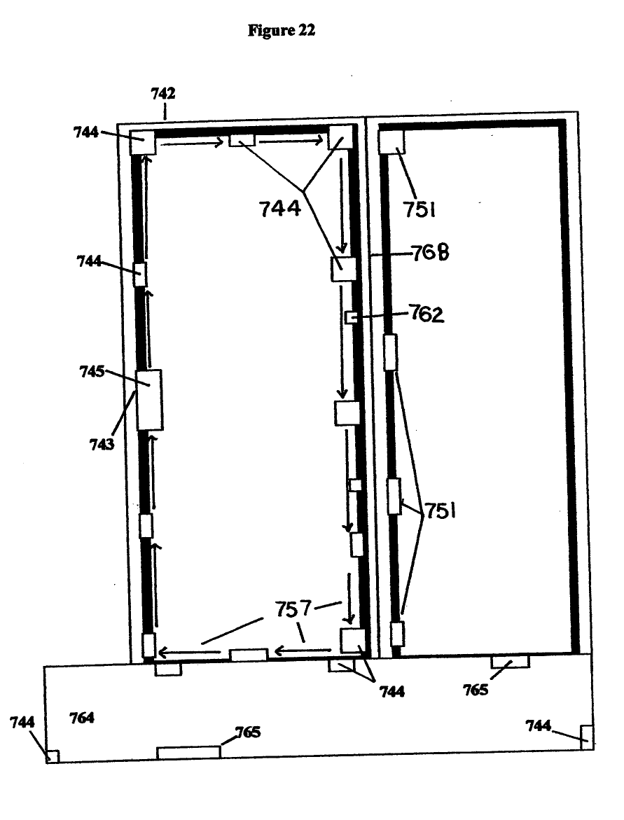

FIG. 22 illustrates where the scanning means of the Fire Nemesis System™'s Fourth Generation Smart Building Scanning means will measure both the horizontal and vertical boundaries of the structure, the thickness of barrier walls, ceiling and floor structures, presence of objects therein, including false barriers, heating ducts, ventilation ducts, gas ports, and the position and place of structures adjacent to the target structure including common access ways, stairwells, and other rooms. Here, the scanning means emits a pulse(s) to the strategically placed sensors to provide a linear scan of the target structure and objects found therein. In turn the scan data will be added to the memory means comprising the database, i.e., layout of the structure. The data from such scans will be combined with and interpreted by the appropriate software of the Smart Building Scanning means to determine the position and dimensions of the structure and objects therein, which will be used to provide both 2-dimensional and 3-dimensional data of the target structure, the fire therein, and thermal topography or thermal differentiation visual data. This data will be transmitted to Fire Nemesis System™'s remote and onsite monitoring means and to fire extinguishment encasement programming means, such as the launcher. Where access is feasible for placement of sensors within adjacent structures (and common areas or passageways), or where the material used in the construction of same will permit (limited) distance penetration of the System's Scanning means scanning through same, the scanning and recording same, as well as active scanning at the time of a fire will permit identification of an area immediately beyond the interior of the target scan structure as well to determine the presence and position of fire within the wall structure and the area immediately contiguous to same.

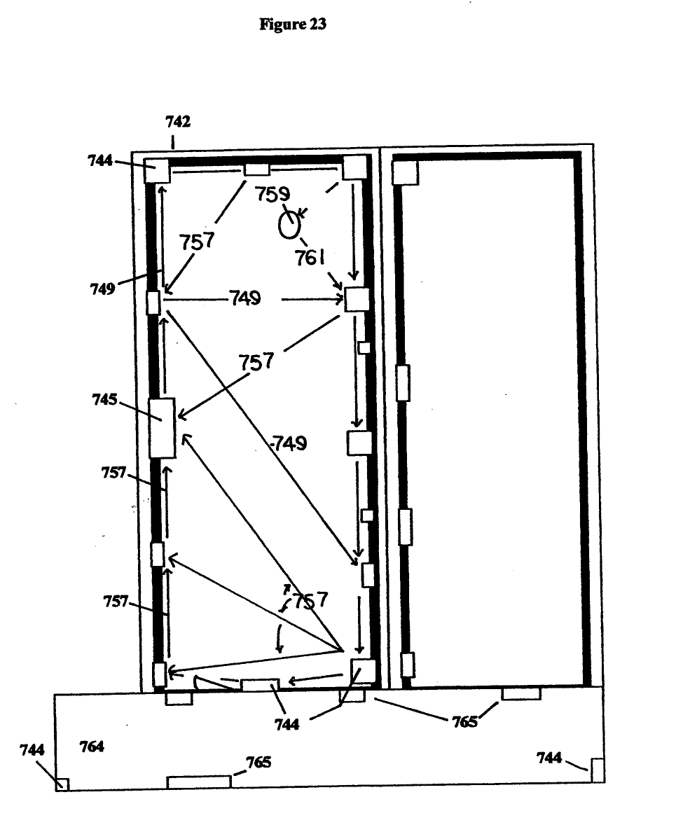

FIG. 23 illustrates an initial cross scanning pattern where the scanning pulse means emitted from the Fire Nemesis System™'s Fourth Generation Smart Building Scanning means returns in a linear and cross pattern to the scanning means, thereby providing both 2-dimensional and 3-dimensional data of the target structure.

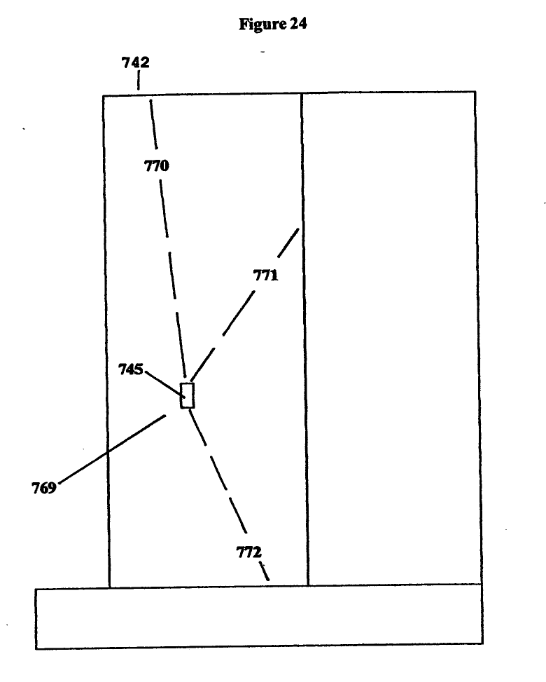

FIG. 24 illustrates the reorientation of the Fire Nemesis System™'s Fourth Generation Smart Building Scanning means subsequent to the unscheduled removal or dislodging from its fixed position: it emits a minimum of three (3) scanning pulses throughout the target structure, comparing the distance, objects and location to conform its new scanning position to the target structure data already on file, within the structure.

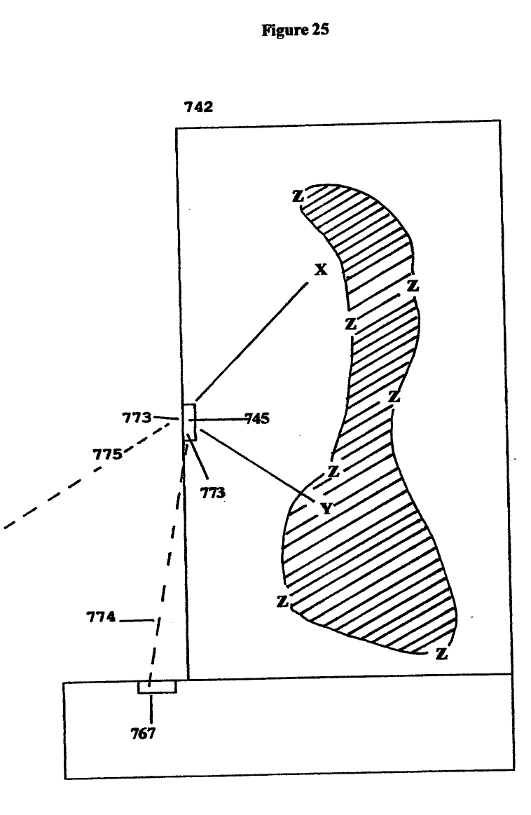

FIG. 25 illustrates the Fourth Generation Fire Suppression Delivery System's Smart Building Scanning means' detection of a fire at Points X, which will then be compared against the structural layout data contained within the scanning mean's memory means, to produces a 2-Dimensional and 3-Dimensional grid/map of target structure and the fire's differentiated thermal range. When linked with the appropriate software it will become possible to determine the potential to become a larger conflagration: such as Point Y. Subsequently, the collective data of this target site and fire will be transmitted to offsite and onsite Fire Nemesis System™'s monitoring means.

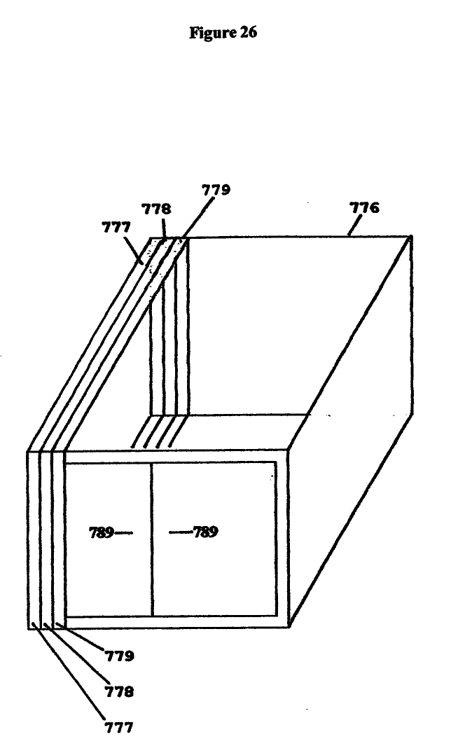

FIG. 26 is a panel section of the Fire Nemesis System™'s Fifth Generation Marine Vessel Containment System, showing its blast proof exterior construction, blast attenuating center section, and high quality insulation interior.

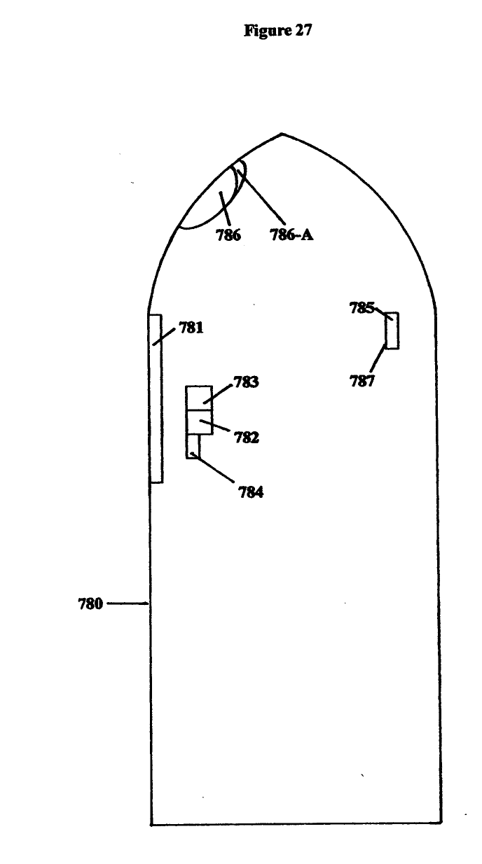

FIG. 27 is a Smart Fire Extinguishment Encasement the Fire Nemesis Syste™'s Fifth Generation Marine Vessel Containment system, modified to serve as a Sentinel Smart Fire Extinguishment Encasement, for application onboard commercial and military marine vessels with personnel accessible compartments.

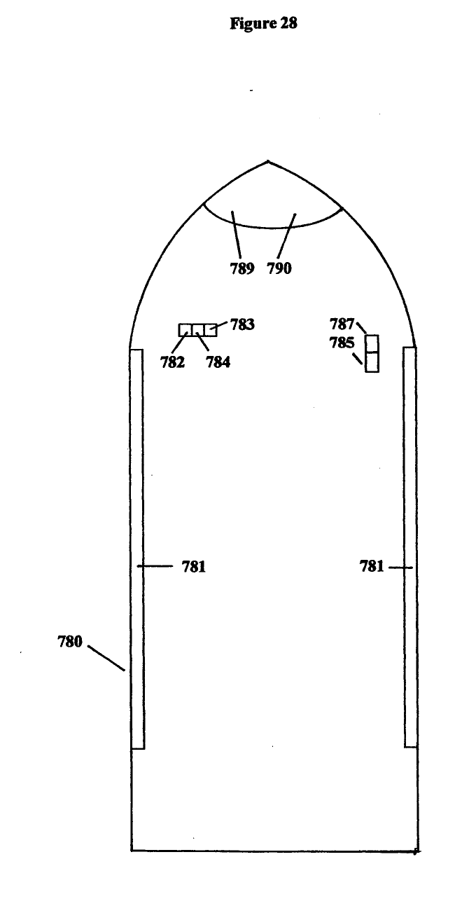

FIG. 28 is a Smart Fire Extinguishment Encasement, of the Fire Nemesis System™'s Fifth Generation Marine Vessel Containment System, where the Smart Fire Extinguishment Encasement is modified for application onboard commercial and military marine vessels with personnel accessible compartments.

### DETAILED DESCRIPTION OF THE INVENTION

### 1. The Fire Nemesis System™ Software Security System

As used herein, the Fire Nemesis System™ Software Security System program means shall mean, a means comprising, a means, method, methodology, mechanism, procedure, software program provision, electronic software program provision, conveyance, technique, process, way, microprocessor controlled, microprocessor initiated, microprocessor aided or assisted, microchip controlled, microchip initiated, microchip aided or assisted, nanotechnology controlled, nanotechnology initiated, nanotechnology aided or assisted, that in some way, shape or manner when activated, turned on, charged, charged with, programmed to recognize an unauthorized attempt to access, reverse engineer, modify, corrupt, interfere with, decompile, tamper with or otherwise to enter, copy, download, upload to, insert, analyze, deconstruct, remove or otherwise to determine the data, encrypted data, non-encrypted data, code, codes, code sequences, source code, operating codes, operating sequence(s), operating code sequence(s), operating means, software operating means, program, program sequence, programming sequence, operating program, operating program sequence of any software component, or similar means of any component, that is a part of the Fire Nemesis System™, when activated to prevent an unauthorized attempt to access the Fire Nemesis System™, will activate the software/program means to prevent such access.

As used herein, a Fire Nemesis System™ Software Security System's multiple embedded, security program means shall also mean, a means comprising three (3) or more means, method, methodology, mechanism, procedure, software program provision, electronic software program provision, conveyance, technique, process, way, that in some way, shape or manner when activated, turned on, charged, charged with, programmed to recognize an unauthorized attempt to access, reverse engineer, modify, corrupt, interfere with, decompile, tamper with or otherwise to enter, copy, download, upload to, insert, analyze, deconstruct, remove or otherwise to determine the data, encrypted data, non-encrypted data, code, codes, code sequences, operating codes, source code, operating sequence(s), operating code sequencers), operating means, software operating means, program, program sequence, programming sequence, operating program, operating program sequence of any software component, or similar means of any component, that is a part of the Fire Nemesis System™, when activated to prevent an unauthorized attempt to access the Fire Nemesis System™, will activate the software/program means to prevent such access.

As used herein, a Fire Nemesis System™ Software Security System's redundant, security program means shall further mean, a means comprising three (3) or more means, method, methodology, mechanism, procedure, software program provision, electronic software program provision, conveyance, technique, process, way, that in some way, shape or manner when activated, turned on, charged, charged with, programmed to recognize an unauthorized attempt to access, reverse engineer, modify, corrupt, interfere with, decompile, tamper with or otherwise to enter, copy, download, upload to, insert, analyze, deconstruct, remove or otherwise to determine the data, encrypted data, non-encrypted data, code, codes, code sequences, source code, operating codes, operating sequence(s), operating code sequence(s), operating means, software operating means, program, program sequence, programming sequence, operating program, operating program sequence of any software component, or similar means of any component, that is a part of the Fire Nemesis System™, when activated to prevent an unauthorized attempt to access the Fire Nemesis System™, will activate the software/program means to prevent such access.

As used herein, a Fire Nemesis System™ Software Security System's first level activatable software security program means, shall mean, a means comprising a means that in some way, shape or manner when activated will prevent the unauthorized attempt to access, reverse engineer, modify, corrupt, interfere with, decompile, tamper with or otherwise to enter, copy, download, upload to, insert, analyze, deconstruct, remove or otherwise to determine the data, encrypted data, non-encrypted data, code, codes, code sequences, operating codes, source code, operating sequence(s), operating code sequence(s), operating means, software operating means, program, program sequence, programming sequence, operating program, operating program sequence of any software component, or similar means of any component that is a part of the Fire Suppression Delivery System, when activated to prevent an unauthorized attempt to access the Fire Nemesis System™, will activate the software/program means to prevent such access.

As used herein, a Fire Nemesis System™ Software Security System's second level activatable software security program means shall mean, a means comprising a means, method, program, programming sequence, program code, programming code, signal(s), method, methodology, mechanism, procedure, mechanical provision, electronic provision, conveyance, technique, process, way, that in some way, shape or manner when activated by the first level activatable means software security program means being compromised, overcome, accessed, bypassed, rendered ineffective, inoperable, or otherwise unable to in some way, shape or manner when activated to prevent an unauthorized attempt to access the Fire Nemesis System™, will activate the software/program means to prevent such access.

As used herein, a Fire Nemesis System™ Software Security System's second level activatable software security program means shall also mean, a means that in some way, shape or manner when activated by detection that the active, independent first level software security system that continually monitors and verifies that an unauthorized attempt to access is interrupted, will cause an alert to be transmitted to a Fire Nemesis System™ remote monitoring means that an unauthorized access attempt was detected that a program sequence indicates the active independent first level software security system has discontinued verifying that a successful attempt to access has not occurred; and, the method or means of the unauthorized attempt to access, e.g., reverse engineering, copying, decompiling recorded, along with any identifying information of the system or user last recorded global positioning system or micro electronic mechanical system setting, time, date, location at the time of the attempt.

As used herein, activation of one or more of the Fire Nemesis System™ Software Security System's multiple, embedded, security program means, redundant security program means by a second level activatable means' failure to prevent access or has been overridden by the intruding means, shall be a means comprising a means that will rapidly cause, in an irretrievable, irreversible, permanent, thorough, complete manner, or as similarly known by those skilled in the art of computer programming, computer program development, to bring about, cause, result in, render all encrypted and unencrypted data of the affected Fire Nemesis System™ software, software controlled system and component, to revert to a single negative or positive binary digit code but never both.

As used herein, activation of one or more of the Fire Nemesis System™ Software Security System's multiple, embedded, security program means, redundant security program means by a second level activatable means' failure to prevent access or has been overridden by the intruding means shall be a means comprising a means that will rapidly cause the insertion, uploading of a means, conveyance, method, mechanism, or similar method that will result in destroying, rendering inoperable, and eliminating all data from the electronic means used to intrude upon the effected Fire Nemesis System™'s programming, software, software controlled systems or components.

As used herein, activation of one or more of the Fire Nemesis System™ Software Security System's multiple, embedded, security program means, redundant security program means by a second level activatable means' failure to prevent access or has been overridden by the intruding means shall be a means comprising a means, that will rapidly cause, in an irretrievable, irreversible, permanent, thorough, complete manner, or as similarly known by those skilled in the art of computer programming, computer program development, the destruction of, self-destruction of, inability to access, operate, run, download, copy, reproduce, reverse engineer the Fire Nemesis System™'s software's source code.

As used herein, activation of one or more of the Fire Nemesis System™ Software Security System's multiple embedded, security program means, redundant security program means by a second level activatable means shall be a means comprising a means that when activated, turned on, charged, charged with, programmed to, manually set to, manually programmed that will rapidly cause, in an irretrievable, irreversible, permanent, thorough, complete manner, or as similarly known by those skilled in the art of computer programming, computer program development, the destruction of, inability to access, operate, run, download, copy, reproduce, reverse engineer the Fire Nemesis System™'s encrypted, unencrypted data, memory.

As used herein, the Fire Nemesis System™ Software Security Systems' fourth level activatable means of the security program means, redundant security program means shall be a means comprising, a means, method, program, programming sequence, program code, programming code, signal(s), method, methodology, mechanism, procedure, mechanical provision, electronic provision, conveyance, technique, process, way, in some way, shape or manner when activated, turned on, charged, charged with, programmed to, manually set to, manually programmed that will rapidly upload to the software means used for unauthorized access to the Fire Nemesis System™'s software means a program, code, sequence or similar means that will convert the software program used render inoperable and eliminate all data from the electronic means used to intrude upon the Fire Nemesis System™'s programming, encrypted and unencrypted data, memory, to the same single binary code, to prevent access, reverse engineer, analysis, copying, decompiling, uploading to, downloading of the anti-intruder sequence, code, program, or means.

As used herein, fragmenting, fragmentation of or multiple fragments of the fourth level activatable means of the security program means, that when activated, turned on, charged, charged with, programmed to, that upon being uploaded to the software means used for unauthorized access to the Fire Nemesis System™'s software, software controlled means, will then become fragmented into several versions of the same code, so as to prevent the intruder system from halting or otherwise preventing or interfering with the fourth activatable mean's intended function and operation, where the fragmented codes are designed to impact upon the intruding system's software, operating system, and memory means at different points of entry therein.

In an embodiment FIG. 1, a block diagram illustrates the two level Software Security System's monitoring system (“Monitoring System”) of the Fire Nemesis System™, where each system or component of the Fire Nemesis System™, including encrypted and non-encrypted data, fire extinguishment encasement, encasement programming means, monitoring means, memory means, CPU, operating system, launch means, discharge means, launch or discharge verification means, encryption means, transceiver, and any similar component or means of the encasement; the launching means; structural, environmental, and thermal scanning means; encasement containment, transport, and storage means; modified firefighting aircraft, modified aircraft and aircraft modified for firefighting purposes, and the unmanned aerial fire suppression drone, that is software controlled, is actively, independently, monitored by its own software security monitoring system to prevent an unauthorized attempt to access, reverse engineer, modify, corrupt, interfere with, decompile, tamper with or otherwise to enter, copy, download, upload to, insert, analyze, deconstruct, remove or otherwise to determine the data, encrypted data, non-encrypted data, code, codes, code sequences, source code, operating codes, operating sequence(s), operating code sequence(s), operating means, software operating means (collectively, “unauthorized access” or “unauthorized access attempt”) of the Fire Nemesis System™'s software, software controlled systems or components.

Here, the First Level Monitor actively monitors the System's software and software controlled systems and components, to detect and prevent any unauthorized access attempt. Where the First Level Monitor detects an unauthorized access attempt it activates an anti-access software program.

The Fire Nemesis System™ Software Security System is safeguarded by multiple, independent, active, Second Level Monitors comprising three sublevel systems. The first sublevel actively, independently, monitors function of the Fire Nemesis System™'s software controlled systems and components to detect any unauthorized attempt to access the System. The second sublevel actively, independently, monitors the System's software controlled systems and components and function of the First Level Monitor to determine whether an unauthorized override of the First Level system has occurred or that it has failed to detect an unauthorized attempt to access the Fire Nemesis System™.

The third sublevel actively, independently, monitors function of other Second Level Monitor to determine whether a Second Level Monitor has been overridden by an unauthorized means, and/or has failed to detect a First Level Monitor failure.

Where the First Level Monitor detects and prevents an unauthorized access attempt the monitoring systems, the monitoring systems continue active, uninterrupted surveillance of the Fire Nemesis System™. However, where the First Level Monitor fails to prevent an unauthorized access attempt, or any of the three Second Level Monitor sublevels detects an unauthorized override of the monitoring means, or a First Level Monitor's failure, or any Second Level Monitor detection failure or an unauthorized override, such will cause the activation of the next activatable level of the software security program that will irreversible convert to negative or positive, but not both, the encrypted and non-encrypted binary data of the Fire Nemesis System™ directly affected by an unauthorized attempt to access; upload to the means used to perform the unauthorized access, a program, code, sequence or similar means that will prevent the intended function of the unauthorized means' software, software source code, and its operating system; which in turn will activate the third activatable means within the uploaded software program that will then irreversibly convert to negative or positive, but not both, the uploaded software program so as to prevent any attempt to reverse engineer, copy, download, access, analyze, obfuscate, deconstruct, upload to, intercept, decompile, tamper with, or interfere with or similar ascertain the program, code, sequence or similar means of the second and third activatable means.

In an embodiment FIG. 2, a block diagram illustrates the interrelation of the First Level Monitor to the System; the Second Level Monitor to the First Level Monitor and the Fire Nemesis System™; and, by and between the multiple, independent, active Second Level monitors.

In an embodiment FIG. 3, a block diagram illustrates the actions of the Monitoring System upon detection of an unauthorized access attempt, where the Monitoring System will transmit to a remote monitoring means of the System an alarm, and data as to the nature of the access attempt, time, date, location of the affected Fire Nemesis System™ software, software controlled systems or components, and any information or data identifying the interloping system.

### 2. The Fire Nemesis System Binary Smart Fire Extinguishment Encasement

As used herein, a modified Smart Fire Extinguishment Encasement for the delivery and activation of foam firefighting material shall mean a modified Smart Fire Extinguishment Encasement for the delivery of foam firefighting source material and its fluid activation medium, to a fire zone, and the activation thereof for the production and ejection of firefighting foam.

As used herein, the impermeable separation barrier of the modified Fire Nemesis System™ Smart Fire Extinguishment Encasement for the delivery and activation of foam firefighting material shall mean a membrane, device, means, membrane or similar structure that will separate the foam material source from the fluid activation medium, and constructed in such a manner that it will withstand the force exerted upon it when loading or charging the Fire Nemesis System™ encasement with the foam material source and the fluid activation medium.

As used herein, bifurcation or a bifurcation barrier of the modified Fire Nemesis System™ Smart Fire Extinguishment Encasement for the delivery and activation of foam firefighting material shall mean the use of an impermeable separation barrier, where its placement within the encasement will in part be determined by the volume of foam firefighting material and required fluid medium respectively, and aerodynamic requirements of the encasement.

As used herein, compromise of the impermeable separation barrier of the modified Fire Nemesis System™ Smart Fire Extinguishment Encasement shall mean a way, action, means or similar act, wherein activation of the associated micro electronic mechanical systems and actuators will cause the barrier to separate, shed, collapse, disintegrate or in similar manner disengage from its points of attachment to internal wall of the encasement, or the force exerted by discharge of the encasement from its launching means, but in such a manner as to not impede mixing of the foam firefighting source material with its fluid activation medium, the mixing device, or the ejection nozzle.

As used herein, acceleration of the foam formation ratio shall mean the injection of a gas, inert gas, or air into the foam agent, subsequent to mixing of the foam firefighting source material with its fluid activation medium, but immediate to its discharge through the ejection nozzle, to the environment.

As used herein, the option application of a gas containment means shall mean a device, means or similar mechanism that will contain pressured gas, that when activated by the software linked and controlled actuators and micro electronic mechanical systems will inject the gas from the containment means into the foam ejection nozzle of the modified Fire Nemesis System™ Smart Fire Extinguishment Encasement, subsequent to mixing of the foam firefighting source material with its fluid activation medium, but immediate to its discharge through the ejection nozzle, to the environment, to accelerate the foam formation ratio.

As used herein, the option application of a micro pump shall mean a device, means or similar mechanism that when activated will inject atmospheric air into the foam ejection nozzle of the modified Fire Nemesis System™ Smart Fire Extinguishment Encasement subsequent to mixing of the foam firefighting source material with its fluid activation medium, but immediate to its discharge through the ejection nozzle, to the environment, to accelerate the foam formation ratio.

As used herein, the option application of a second micro pump shall mean a device, means or similar mechanism that when activated will pump atmospheric air into the modified Fire Nemesis System™ Smart Fire Extinguishment Encasement to pressurize the contents therein, to facilitate foam formation and ejection.

In an embodiment FIG. 4 illustrates a modified Fire Nemesis System™ Smart Fire Extinguishment Encasement (799) for the delivery and activation of foam firefighting material. Here, the barrier (798) (attached to micro electronic mechanical systems and actuators) separates the foam material source (800) from its interacting fluid medium (801), that when mixed together will result in production of the firefighting foaming agent. The activatable means liked to the software control means of the micro electronic mechanical systems and actuators (805), programming, trajectory, navigation and discharge means of the encasement will activate the device (797) that will compromise the separation barrier: subsequent to discharge from the launching means, on approach to the target fire zone, or upon access the target zone, to initiate mixing of the foam material source with its fluid medium. This will result in activation of the second activatable means that controls the second device (806) that will mix the foam material source (800) with the fluid medium (801), subsequent to degradation of the barrier (798). The ejection of air or gas (such as nitrogen) under pressure to the firefighting foam agent from the high pressure gas (802) from the containment means (795) connected to the ejection nozzle (794 or 793), controlled by micro electronic mechanical systems (802) and actuators (802) immediately prior to the discharge of foam through the ejection nozzle will accelerate the foam mixing and formation ratio as the foam is expelled to the environment (803). Alternatively, the micro electronic mechanical systems (802) and actuators (802) will activate a micro pump (804) or similar means that will draw air from the environment and inject it under pressure, to the ejection nozzle (794, 793) and the firefighting foaming agent. Point 796 illustrates optional placement of the high pressure gas containment means for aerodynamic and trajectory balance purposes, with connecting lines to the ejection nozzle(s) (793, 794). Point 807 illustrates optional design inclusion of a micro pump to pressurize the encasement, its contents, to facilitate foam formation and ejection, subsequent to discharge of the Fire Nemesis System™ encasement from its launching means.

Here, the diagrammed barrier that bifurcates the Fire Nemesis System™'s binary Smart Fire Extinguishment Encasement, is shown in its current state for illustrative purposes only. Actual placement of the barrier (798) will depend upon specific design parameters and the required fluid medium to foam source material ratio: as too, the number of and placement of the ejection nozzle(s) (794, 793).

In another embodiment FIG. 5 illustrates a modified Fire Nemesis System™'s binary Smart Fire Extinguishment Encasement where the barrier (798) that separates the foam material source (800) from its activating fluid medium (801) is compromised by activation of its actuators (805), so as to facilitate mixing of the fluid (801) with the foam material source to produce the firefighting foaming agent.

### 3. The Fire Nemesis System Fire Extinguishment Encasement Airbrake

As used herein, an activatable means of the Fire Nemesis System™ fire extinguishment encasement shall be a means comprising a means, method, methodology, mechanism, procedure, mechanical provision, electronic provision, conveyance, technique, process, way, microprocessor controlled, microprocessor initiated, microprocessor aided or assisted, microchip controlled, microchip initiated, microchip aided or assisted, nanotechnology controlled, nanotechnology initiated, nanotechnology aided or assisted, micro electronic mechanical systems controlled or initiated, that in some way, shape or manner when activated, will cause the fire extinguishment encasement to deploy a means to steer, redirect, change, modify, deflect, deflect the orientation of, pathway of, maneuver, reduce the speed of, increase drag, or to stop its forward progression, subsequent to being discharged from a launching means.

As used here in this invention, a projectile airbrake means to steer, redirect, change, modify, deflect, deflect the orientation of, pathway of, maneuver, reduce the speed of, increase drag, or to stop a projectile's forward progression shall be a means comprising a structure, component, fin, wing, flange or similar structure (referred to as an “airbrake” or “projectile airbrake”), that when is activated and deployed to the exterior of the fire extinguishment encasement, shall cause the projectile steer, redirect, change, modify, deflect, deflect the orientation of, pathway of, maneuver, reduce the speed of, or to stop its forward progression. As also used herein, a projectile airbrake means shall be a means comprising, a means, method, methodology, mechanism, mechanical provision, conveyance or similar means, that when linked to the appropriate software means of the Fire Nemesis System™ fire extinguishment encasement's trajectory, programming, discharge, and targeting means that when activated will steer, redirect, change, modify, deflect, deflect the orientation of, pathway of, maneuver, reduce the speed of, increase the drag of, or to stop the forward progression of the fire extinguishment encasement during its trajectory.

In an embodiment FIG. 6, illustrates several projectile braking devices (700) housed or suspended within the Fire Nemesis System™ fire extinguishment encasement. In an inactive state below the Fire Nemesis System™ fire extinguishment encasement's exterior surface, and maintained to the sub-exterior surface or interior of the fire extinguishment encasement.

In another embodiment FIG. 7, several projectile braking devices (700), in an inactive, non-activated state, illustrated apart and alone from the Fire Nemesis System™ fire extinguishment encasement housing; that can be grouped together (though not limited to) in a horizontal ring or in an elliptical fashion, or in a circular fashion, that when activated will be deployed to the exterior surface of the Fire Nemesis System™ fire extinguishment encasement, and exposed to the exterior environment.

In another, continued embodiment, FIG. 8, several Fire Nemesis System™ fire extinguishment encasement projectile braking devices (700), in an activated state, are displayed apart from the Fire Nemesis System™ fire extinguishment encasement housing, which can be grouped in a ring or in an elliptical fashion, or in a circular fashion, in two (701, 702) of more sections that with activation will become deployed to the exterior surface of the Fire Nemesis System™ fire extinguishment encasement, exposed to the exterior environment.

In a continued embodiment FIG. 9, several Fire Nemesis System™ fire extinguishment encasement projectile braking devices (700), in an inactive, non-activated state, are displayed apart from the fire extinguishment encasement housing, that can be grouped in a ring or in an elliptical fashion, or in a circular fashion, in two of more sections, that when activated will be deployed to the exterior surface of the fire extinguishment encasement and exposed to the exterior environment.

In yet another embodiment FIG. 10, illustrates an Fire Nemesis System™ fire extinguishment encasement comprising a set of projectile braking devices (703) to the fore section of the fire extinguishment encasement (1), and a second set of projectile braking devices (704) to the aft section of the fire extinguishment encasement, that when activated will be deployed to the exterior surface of the fire extinguishment encasement and exposed to the exterior environment.

In a further embodiment FIG. 11 illustrates several activated (705) projectile braking devices (700) deployed by extending them outward, from the Fire Nemesis System™ fire extinguishment encasement's interior cavity to the exterior environment, to increase drag during the Fire Nemesis System™ fire extinguishment encasement's trajectory.

As used herein, a Fire Nemesis System™ fire extinguishment encasement projectile airbrake means shall also mean a Fire Nemesis System™ fire extinguishment encasement design comprising a ganged set of projectile braking devices, in an inactive, non-activated state, affixed to a vertical ring or in an elliptical fashion, or in a circular fashion, housed by the Fire Nemesis System™ fire extinguishment encasement with its most distal point of the brake means at or near the exterior surface of the Fire Nemesis System™ fire extinguishment encasement, thereafter extending inward to the interior of the encasement to the attaching ring, so that when activated the attaching ring, whether a unitary ring or segmented to form discrete ganged sections, will cause the braking means to extend through the exterior surface of the Fire Nemesis System™ fire extinguishment encasement, to the exterior environment, and achieve the desired angle to create drag, change the orientation, pathway, maneuver, reduced speed, or to stop the forward progression of the fire extinguishment encasement, during its trajectory.

As used herein, a Fire Nemesis System™ fire extinguishment encasement projectile airbrakes means shall further mean a Fire Nemesis System™ fire extinguishment encasement comprising ganged or non-ganged, flat surface or horizontal braking devices that conform with the shape and curvature of the encasement, in an inactive, non-activated state, affixed in a horizontal fashion flush with or near the exterior surface of the Fire Nemesis System™ fire extinguishment encasement, so that when activated the attaching ring, whether a unitary ring or segmented to form discrete ganged sections, will cause the distal end of the braking means to extend vertically from the exterior surface of the Fire Nemesis System™ fire extinguishment encasement to the exterior environment, and achieve the desired angle to create drag, change the orientation, pathway, maneuver, reduced speed, or to stop the forward progression of the encasement.

As used herein, the Fire Nemesis System™ fire is extinguishment encasement projectile airbrake means shall yet further mean a Fire Nemesis System™ fire extinguishment encasement comprising ganged or non-ganged, parabolic shape projectile braking device, in an inactive, non-activated state, affixed in a horizontal fashion flush with or near the exterior surface of the Fire Nemesis System™ fire extinguishment encasement, so that when activated, the attaching ring, whether a unitary ring or segmented to form discrete ganged sections, will cause the distal end of the braking means to extend vertically from the exterior surface of the Fire Nemesis System™ fire extinguishment encasement to the exterior environment, and achieve the desired angle to create drag, change the orientation, pathway, maneuver, reduced speed, or to stop the forward progression of the Fire Nemesis System™ fire extinguishment encasement.

As used herein, activated parabolic shape projectile braking device of the Fire Nemesis System™ fire extinguishment encasement projectile shall mean a parabolic shaped device that when extended beyond the encasement's exterior surface and forming a parabolic shaped protrusion, so that when the desired angle to create drag is achieved, the orientation, pathway, maneuver, speed, or forward progression of the Fire Nemesis System™ fire extinguishment encasement will be effected as desired.

As also used here, whether using a single line of devices (FIG. 6) or a dual or greater number of devices (FIG. 10) the intent is to control the pitch and maneuverability of the Fire Nemesis System™ fire extinguishment encasement projectile during its trajectory, for efficient delivery of the Fire Nemesis System™ fire extinguishment encasement to the intended target or target area. Several devices can be ganged together, so that each ganged series may be activated independently, simultaneously, or in tandem. This may serve as a Fire Nemesis System™ fire extinguishment encasement safety feature, of the Fire Nemesis System™ Aerial Fire Suppression Drone to change the Fire Nemesis System™ fire extinguishment encasement's trajectory to avoid striking an individual within its trajectory. By limiting the number of ganged devices deployed, or deploying one (or more) ganged devices at one angle, while deploying a different set of ganged devices at the converse or opposing angle, the Fire Nemesis System™ fire extinguishment encasement can be steered into or toward a given direction or pathway: the device serves as a projectile brake.

### 4. The Fire Nemesis System™ Aerial Fire Suppression Drone Modifications

As used herein, internally fitted, insulated ceramic tiles, high quality insulation means or similar means such as applied to the Space Shuttle Orbiter, shall be a means comprising the use of a material, composition, substrate or similar substance comprising the ability to withstand extreme heat, flames, fire over an extended period of time, that is fitted, affixed, attached or otherwise made a part of the interior surface, chamber of the Fire Nemesis System™ Aerial Fire Suppression Drone, that will also divert, re/direct, dissipate heat infiltrating from the external environment and heat within the internal environment of the Fire Nemesis System™ Aerial Fire Suppression Drone, away from its interior to the external environment.

As used herein, internally fitted, insulated ceramic tiles, high quality insulation means or similar means, shall also be a means comprising an insulating material just as or similar to that of the insulating tiles or surfaces utilized to protect the outer surface of the Space Shuttle Orbiter on re-entry to the earth's atmosphere, constructed in a manner and with a material that will also withstand the impact of debris common to the fire environment that may impact with the exterior of the Fire Nemesis System™ Aerial Fire Suppression Drone or similar aircraft.

As used herein, externally fitted, insulated ceramic tiles, high quality insulation means or similar means such as applied to the Space Shuttle Orbiter, shall be a means comprising the use of a material, composition, substrate or similar substance comprising the ability to withstand extreme heat, flames, fire over an extended period of time, that is fitted, affixed, attached or otherwise made a part of the exterior surface, chamber of the aircraft, that will also divert, re/direct, dissipate heat from the external environment away from its interior to the external environment.

As used herein, externally fitted, insulated ceramic tiles, high quality insulation means or similar means, or shall also be a means comprising an insulating material just as or similar to that of the insulating tile surfaces utilized to protect the outer surface of the Space Shuttle Orbiter on re-entry to the earth's atmosphere, constructed in a manner and with a material that will also withstand the impact of debris common to the fire environment that may impact with the exterior of the aircraft.

As used herein, fuselage strengthening or similar means, shall also mean, a means comprising a, material, substance, composition, construction, manner of construction or manufacturer, manner, means, provision, technique or similar method or methodology that will render the exterior surface of the Fire Nemesis System™ Aerial Fire Suppression Drone's fuselage resistant to penetration without significantly increasing the weight of the aircraft, particularly so as to resist, prevent or similarly repel the penetration of debris or projectiles common to a fire environment, that may strike the aircraft while operating proximate to or within the fire zone.

As also used herein, the Fire Nemesis System™ Aerial Fire Suppression Drone fuselage strengthening or similar means, shall further mean, a means comprising a material, substance, composition, construction, manner of construction or manufacturer, manner, means, provision, technique or similar method or methodology that will render the exterior surface of the Fire Nemesis System™ Aerial Fire Suppression Drone fuselage resistant to penetration, without significantly increasing the weight of the aircraft, particularly so as to resist, prevent or similarly repel the penetration of debris or projectiles common to a fire environment that may strike the aircraft while operating proximate to or within the fire zone, that is also capable of, given sufficient force by the aircraft, that when said aircraft strikes or moves against tree limbs while operating within the fire environment, will cause such limbs to break away without causing damage or injury to, or penetration of, or becoming lodged against or within the fuselage of the aircraft.

As used herein, the Fire Nemesis System™ Aerial Fire Suppression Drone fuselage self fire-extinguishing material or similar means shall also mean, a means comprising a material, substance, composition, construction, manner of construction or manufacturer, manner, means, provision, technique or similar method or methodology that when struck by, penetrated by or semi-penetrated by a material or substance which may otherwise cause the fuselage to ignite, will rapidly extinguish the fire.

As used herein, an inert gas backfill of the interior or interior chamber of the Fire Nemesis System™ Aerial Fire Suppression Drone or similarly constructed aircraft shall mean, a means comprising construction of the interior of the aircraft in such a manner that it can be filled with and will retain an inert gas as a backfill that will attenuate, absorb, or similarly lessen the impact exerted by structures striking the exterior surface of the fuselage.

As used herein, a Fire Nemesis System™ Aerial Fire Suppression Drone mid-air refueling means, shall be a means comprising a way, conveyance, method, system, device or similar means, as known by those familiar with aircraft design and military aircraft operations, that will allow a receiving aircraft to be refueled by a second aircraft, while both aircraft are in flight.

As used herein, a Fire Nemesis System™ Aerial Fire Suppression Drone mid-air fire extinguishment replenishing means or reloading means mean a means comprising a way, conveyance, method, system, device or similar analogous to systems known by those familiar with aircraft design and military aircraft operations that will allow a receiving aircraft to be refueled by a second aircraft, while both aircraft are in flight, where instead of fuel the fire extinguishment material is being reloaded to the aircraft while in flight.

As used herein, a Fire Nemesis System™ Aerial Fire Suppression Drone mid-air or aerial docking means shall mean, a means comprising a way, method, conveyance, mechanism or similar means that when linked to the appropriate software means will permit attachment of the Fire Nemesis System™ Aerial Fire Suppression Drone to align itself with, attach to, secure itself to or similarly join itself to the fuselage or fuselage attachment of a second aircraft, while both aircraft are in flight, for deployment of the Fire Nemesis System™ Aerial Fire Suppression Drone to and from a fire zone or other area, for mid-air deployment from a carrier aircraft, or for mid-air refueling and/or extinguishment replenishment.

As used herein, the appropriate software means linked with an aircraft or aerial docking means comprising a software, computer, wireless or similar program means that is linked to and operating in conjunction with an analogous program of the receiving docking means of the second aircraft, as well as being linked to its avionics control means to facilitate mid-air docking, deployment of the Fire Nemesis System™ Aerial Fire Suppression Drone from a second aircraft, as well as refueling and extinguishment replenishment shall mean a software program or similar means capable of performing or causing to be performed such functions.

As used herein, mid-air drop flight delivery of the Fire Nemesis System™ Aerial Fire Suppression Drone shall mean, a means comprising in-flight deployment of the Fire Nemesis System™ Aerial Fire Suppression Drone from the fuselage of a carrier aircraft, or from within the interior of same to the environment, whereupon deployment of the Fire Nemesis System™ Aerial Fire Suppression Drone to the environment shall coincide with activation of the aircraft's propulsion, avionics and guidance means.

As used herein, an alternate power generation means of the Fire Nemesis System™ Aerial Fire Suppression Drone shall be a means comprising a system, device, mechanism, conveyance, means or similar method with the capacity to harness the thermal energy from a fire zone while an aircraft is operating within same, by superheating a fluid or gas within its containment means, that when linked with a power generating means through which the superheated fluid or gas is circulated to, the energy generated will power the propulsion means of the aircraft before being circulated to a condenser unit that will cool the fluid or gas before it returns to the containment means first used to harness the thermal energy of the fire.

As used herein, by linking the alternate power generations means, the propulsion means, and appropriate controls to monitor propulsion and thermal conditions, propulsion operations of the aircraft can be returned to its standard propulsion means where thermal conditions within or proximate to the fire zone will not support use of the alternate power generation means.

The alternate power generation means will facilitate operations of the Fire Nemesis System™ Aerial Fire Suppression Drone or similar aircraft within the fire zone, where use a propulsion means requiring but limited to an external supply of oxygen for proper fuel combustion will be compromised by oxygen depletion within or proximate to the fire zone.

As used herein, the propulsion means of the Fire Nemesis System™ Aerial Fire Suppression Drone shall mean, a means comprising, a propulsion means, method, mechanism, system, mechanical provision, electronic provision, conveyance that is affixed, mounted to, mounted within, partially mounted within, or similarly placed respective to the fuselage of the aircraft in such a manner so that it will partially extend outward from exterior of the fuselage, as opposed to being affixed in such a manner that its primary propulsion means is completely or extensively located to the exterior of the fuselage or surface of the aircraft.

As used herein, the propulsion means of the Fire Nemesis System™ Aerial Fire Suppression Drone shall also be a means comprising, a propulsion means, method, mechanism, system, means, mechanical provision, electronic provision, conveyance that is completely mounted within the fuselage of the aircraft in such a manner that it will not extend to the exterior surface of the aircraft.

As used herein, the propulsion means of the Fire Nemesis System™ Aerial Fire Suppression Drone shall also be a means comprising a propulsion means, method, mechanism, system, means, mechanical provision, electronic provision, conveyance, technique, process, way, microprocessor controlled, microprocessor initiated, microprocessor aided or assisted, microchip controlled, microchip initiated, microchip aided or assisted, nanotechnology controlled, nanotechnology initiated, nanotechnology aided or assisted, micro electronic mechanical system controlled or aided, that in some way, similar means that is affixed, placed, built into, designed to, housed, or constructed in such a manner, position, place, area or similar notation, so that it is completely shrouded or enclosed within the fuselage of the drone, as opposed to being affixed in such a manner that its primary propulsion means is located to the exterior of the fuselage or the surface of the drone, so that when linked to the appropriate fuel provision means, avionic system, air intake means, and activated, will provide horizontal and vertical path movements of the aircraft, the axis of the engine and its thrust can be moved, repositioned, or similarly rotated in such a manner, including while the aircraft is in flight, so as to allow the aircraft to be piloted in a forward, rearward, lateral horizontal direction, as well as vertical flight control and hovering.

As used herein, the shroud of the Fire Nemesis System™ Aerial Fire Suppression Drone's propulsion means shall mean the exterior surface, cover, partial cover, covering, covering means, mechanism, system, method, process or similar means that extends, projects outward from the fuselage to the external environment, that will partially encase the rotary or turbofan engine of the Fire Nemesis System™ Aerial Fire Suppression Drone, while not interfering with function of the propulsion means.

As used herein, the shroud of the Fire Nemesis System™ Aerial Fire Suppression Drone's propulsion means shall also mean the exterior surface, cover, partial cover, covering, covering means, mechanism, system, method, process or similar means constructed in such a manner and of a material sufficient to withstand exposure to extreme operating temperatures of the propulsion means, as well as that of the fire environment, at temperatures of 3,000° F. or greater; that will also shield the propulsion means from impact by debris common to an evolved fire zone.

As used herein, the shroud of the Fire Nemesis System™ Aerial Fire Suppression Drone's propulsion means shall further mean a means comprising the exterior surface, cover, partial cover, covering, covering means, mechanism, system, method, process or similar means that can be extended and retracted as required to meet the operational requirements of the Aerial Fire Suppression Drone's propulsion means.

As used herein, the ducted propulsion means of the Fire Nemesis System™ Aerial Fire Suppression Drone shall further mean, a means comprising a ducting means through which the exhaust of the rotary or turbofan engine is vented from the engine to ports within the fuselage, to the external environment, as required to meet the operational requirements of the Aerial Fire Suppression Drone's propulsion means.

As used herein, an exhaust vectoring means of the Fire Nemesis System™ Aerial Fire Suppression Drone's propulsion means shall be a means comprising a method, surface, projection, mechanical provision, electronically controlled provision, mechanically controlled provision, conveyance, process, way, or similar means, that is attached to, a part of, connected to or similarly adjoined to the external ridge of the fuselage.

As used herein, an exhaust vectoring means of the Fire Nemesis System™ Aerial Fire Suppression Drone's propulsion means that is attached to, a part of, connected to or similarly adjoined to the external ridge of the fuselage shall further mean a means comprising a method, surface, projection, mechanical provision, electronically controlled provision, mechanically controlled provision, conveyance, process, way, or similar means, that is microprocessor controlled, microprocessor initiated, microprocessor aided or assisted, microchip controlled, microchip initiated, microchip aided or assisted, nanotechnology controlled, micro electronic mechanical system assisted, nanotechnology initiated, nanotechnology aided or assisted, that when linked to the appropriate avionics or similar means controlling the propulsion means of the aircraft, can be manipulated to control, direct, redirect the path of the thrust created by the propulsion means.

As used herein, exhaust vectoring of the Fire Nemesis System™ Aerial Fire Suppression Drone's propulsion means shall mean a means comprising a means a mechanical provision, conveyance, technique, process, way, microprocessor controlled or similar control means, will control the direction of the exhaust generated by the propulsion means.

As used herein, exhaust vectoring of the Fire Nemesis System™ Aerial Fire Suppression Drone's propulsion means shall mean a means comprising a means a mechanical provision, conveyance, technique, process, way, microprocessor controlled or similar control means, will control the direction of the exhaust generated by the propulsion means, from the propulsion means through ports within the fuselage to the external environment, so as to provide sufficient force to effect vertical lift and descent of the aircraft, and hovering.

As used herein, fire extinguishment dispersal through the vectoring means of the Fire Nemesis System™ Aerial Fire Suppression Drone (325), shall be a means comprising a means to deliver, port, introduce or similarly to eject the fire extinguishment to the environment through and along with the downward or outward thrust produced by the turbofan or rotary engine or other means of propulsion of the Fire Nemesis System™ Aerial Fire Suppression Drone.

In an embodiment, FIG. 12, illustrates a cutaway horizontal view of the Fire Nemesis System™ Aerial Fire Suppression Drone (325), where the exterior hardened surface of the fuselage (706) is fitted with high quality insulation (356/709), similar to what is used for the Space Shuttle Orbiter to deflect the extreme heat associated with a fully evolved fire; replaceable high quality insulation which can be fitted to the interior wall of the fuselage (708), the exterior surface (711) or the interior surface (710) of the interior chamber (707). The space or chamber (712) between the fuselage (706) and the interior chamber (707) is backfilled with an inert gas from the containment means (713) to absorb impact of debris common to a fire zone striking the fuselage, as well as residual heat from the fire environment that was not deflected by the high quality insulation. Regulation (714) of the inert gas and removal of same from the interior chamber area (712) between the fuselage (706) and the interior component chamber (707) is via a compressor (715) linked between the airtight chamber (712), the gas containment means (713), and appropriate software.

In an embodiment, FIG. 13 illustrates a Fire Nemesis System™ Aerial Fire Suppression Drone (325) where the thermal capture unit (716) located at or near the surface of the fuselage (706), contains the working fluid (718) that will be superheated by the heat from the fire zone, to be pumped (717) through an insulated connection (719) to the power generation means (720) that will generate power necessary for transfer to the propulsion means (722, 723, 724 and 725). The superheated fluid or gas utilized by the power generation means (720) via an insulated connection (726) to the condenser (727) that will reduce the heat while generating additional electrical power before circulating via an insulated connection (728) to the thermal capture unit (716), is intended to produce sufficient power to sustain operation of the fuselage enclosed or semi enclosed propulsion means, and electrical system where in turn the thrust produced by the propulsion means will be ducted to the thrust vectoring ports strategically placed within the fuselage.

In an embodiment, FIG. 14, illustrates thrust vectoring ports (731) or exhaust thrust vectoring exhaust ports (731) of the Fire Nemesis System™ Aerial Fire Suppression Drone (325) strategically placed at the surface of the Fire Nemesis System™ Aerial Fire Suppression Drone's (325) fuselage (706) to provide lift required to sustain vertical flight/hovering (while the Fire Nemesis System™ Aerial Fire Suppression Drone [325] is in the fire zone or performing vertical take off and landing procedures).

In an embodiment, FIG. 15, as at FIG. 13, illustrates dual thermal capture units (716) and dual propulsion means (723, 724) of the Fire Nemesis Syste™ Aerial Fire Suppression Drone (325). Here, a dual set of thermal capture units (716), pumping means (717), power generation means (720) and condenser (727) are centralized within the fuselage for load distribution purposes (for illustrative purposes only). Here, two propulsion means (723, 724) are placed fore and aft of the Fire Nemesis System™ Aerial Fire Suppression Drone, where the exhaust is ducted (730) to the thrust vectoring ports (731) strategically placed to provide and sustain lift. A heat exchanger (729) is attached to the propulsion means (723, 724) that is vented to the exterior surface of the fuselage (706) and/or to the thermal capture unit (716-728), to prevent heat buildup within the fuselage and the propulsion containment area. Although illustrated as containing dual thermal capture units (716-728) and dual propulsion means (723, 724), and four thrust vectoring ports (731), the actual number of thermal capture units, proposal means, and thrust vectoring ports will depend upon actual design specifications, accounting for space, weight, power generation capacity and power needs, payload and other factors.

In an embodiment, FIG. 16, illustrates a limited vertical view of the Fire Nemesis System™ Aerial Fire Suppression Drone (325), with its horizontal flight wing (725) deployed from the aft or underside of the aircraft, and the tail rudder assembly (733) fully extended for horizontal flight. Here, exterior fuselage doors (726) are opened. The exterior fuselage doors (736) can house shorter, deployable wings or canards, for aircraft stabilization while in hover mode and within a fire zone, as well as to house the longer horizontal flight wing when the latter is retracted and moved by a slide track or similar means within the fuselage leading to the side or underside wing housing area of the fuselage.

In an embodiment, FIG. 17 and FIG. 18, illustrate full deployment of the shorter stabilizing wings (734, 735). Here the horizontal flight wings (725) are retracted and housed behind the Fire Nemesis System™ Aerial Fire Suppression Drone's protective fuselage doors (736). When the Fire Nemesis System™ Aerial Fire Suppression Drone fuselage doors are closed (737), the protective fuselage doors (736) will shield the horizontal flight wing (725) from the fire and from the impact of debris common to the fire zone. Here, the tail rudder assembly (733) is retracted into the tail area of the fuselage (739) and housed within the tail of the fuselage (738). This will reduce surface area exposure to the fire environment and potential damage by striking debris and other objects while operating within the zone. When the Fire Nemesis Syste™ Aerial Fire Suppression Drone (523) is extricated from the fire zone the tail rudder housing assembly (733) and the horizontal flight wing (725) are extended and secured in their normal horizontal flight positions; with the shorter stabilizing wings (734, 735) retracted and secured behind the fuselage protective doors (736). The fuselage protective doors (736) comprise the same high quality insulation and fuselage strengthening material found throughout the fuselage of the aircraft.

In an embodiment, FIG. 19 illustrates a limited horizontal view of the Fire Nemesis System™ Aerial Fire Suppression Drone fuselage (706) where the shorter stabilizing wings (734, 735) are fully deployed. As illustrated here, the shorter stabilizing wings (734, 735) can be moved in a horizontal arch (740, 741): this, combined with its thrust vectoring capacity is to effect optimal hovering and stabilization of the aircraft.

As used herein, a Fire Nemesis System™ vertical flight Aerial Fire Suppression Drone shall mean a Fire Nemesis System™ Aerial Fire Suppression Drone or similar unmanned and/or remote operated aircraft modified for vertical flight operations within, but not limited to, an environmental fire zone.

As used herein, a Fire Nemesis System™ vertical flight Aerial Fire Suppression Drone shall also mean a Fire Nemesis System™ Aerial Fire Suppression Drone or similar unmanned and/or remote operated aircraft modified for vertical flight operations within, but not limited to, a structural fire zone.

As also used herein, a Fire Nemesis System™ vertical flight Aerial Fire Suppression Drone for structural fire zone operations shall mean the Fire Nemesis System™ Aerial Fire Suppression Drone designed for vertical flight maneuvers within and to pass through, enter or similarly gain access and egress through limited access openings, corridors, common ways and similar access or egress means common to a high-rise, commercial, industrial, underground transportation infrastructure or similar structures.

As used herein, use of a canard or vertical flight canard wing by the Fire Nemesis System™'s vertical flight Aerial Fire Suppression Drone shall mean, the use of two or more short wings to provide vertical flight stabilization of an aircraft that can be pitched, angled or similarly oriented during flight maneuvers, and to assist with stable vertical rotation of the aircraft.

As used herein, a limited exhaust thrust diversion or diverter for application with the Fire Nemesis System™ vertical flight Aerial Fire Suppression Drone shall mean a device, method, mechanism or similar means that when activated will divert a portion of the exhaust stream generated by the propulsion means passing through the exhaust duct system used to sustain vertical lift and flight, to strategically placed alternate thrust vectored ducts to effect rotation or horizontal movement of the aircraft.

As used herein, a Fire Nemesis System™ vertical flight Aerial Fire Suppression Drone shall further mean an unmanned and/or remote operated vertical flight Aerial Fire Suppression Drone comprising at least one or more fire extinguishment material containment means, capable of sustaining 10,000^{Psi} or greater.

As used herein, the application of one or more 10,000^{Psi} or greater fire extinguishment material containment means within a Fire Nemesis System™ vertical flight Aerial Fire Suppression Drone shall further mean the use alternatively to temporarily contain oxygen extracted from the fire environment as fire extinguishment material is ejected, and mixed with an inert gas.

As used herein, a high speed or high impact environmental oxygen extractor of the Fire Nemesis System™ vertical flight Aerial Fire Suppression Drone shall be a means comprising a device, system, mechanism or similar means to extract oxygen from the environment of the structural fire zone the aircraft is operating within, in an intent to reduce the amount of free oxygen available to a fire to less than 16% of total oxygen per volume in the structural fire zone of operation.

In an embodiment FIG. 20 illustrates a vertical view of the Fire Nemesis System™ vertical flight Aerial Fire Suppression Drone, where the proposed construction is to develop same around the 10,000^{Psi} fire extinguishment material containment means and/or fire extinguishment encasement containment means, that is connected to the ejection means (814) by micro electronic mechanical means, actuators and pumping means, where here, for illustrative purposes, the alternate propulsion means (723) contained within the fuselage (325), where its exhaust stream is ducted (731) to exhaust ports (813, 816) in the fuselage also comprising exhaust thrust vectoring vanes. The canards (734, 735), a shorter wing, replaces a standard (length) horizontal flight wing for vertical flight stabilization and hovering.

In an embodiment FIG. 21 illustrates the parachute or parasail (809) and its housing area (810) that is actuator and software controlled for deployment upon discharge from a carrier aircraft to a fire zone, which will guide and slow descent of the Fire Nemesis System™ vertical flight Aerial Fire Suppression Drone. Use and deployment of a parasail as opposed to a standard parachute, when linked to the appropriate control means, the aircraft's navigation, targeting, guidance and tracking means will provide greater control and accuracy in drop delivery of the aircraft to the fire zone and the impact of the fire's thermal updraft. The use of multiple canards (734, 735) will stabilize the aircraft during vertical flight operations and rotation. To assist with horizontal movement of the aircraft, a portion of the aircraft's ducted propulsion exhaust stream can be (diverted) to lateral vectored/exhaust ports (816). The use of independently retractable and controlled (thermal) deflection struts (811), when deployed (815) is intended to deflect the thermal stream and updraft created by the fire zone to augment stabilization of the aircraft.

### 5. Fire Nemesis System™ Fourth Generation Smart Building Fire Suppression Delivery System

As used herein, the Fire Nemesis System™ Fourth Generation Smart Building System's scanning housing means shall mean a containment means comprising, structure, means, method, device or similar structure comprising or similarly confining the Fire Nemesis System™ Fourth Generation Smart Building System's scanning means, and further comprising:
A. A structure for attachment, securing, affixing the scanning means to;
B. A rotational means, moveable base, or similar mechanism that will allow for movement of the scanning means;
C. A self-righting means to position or reposition the scanning means;
D. A Global Positing System means;
E. An accelerometer, Micro Electronic Mechanical System (“MEMS”), altimeter or other self-contained height and movement measuring means;
F. Safety or intrusion detection alert and prevention means;
G. Fire Nemesis System™ Software security and intrusion detection means;
H. Scanning means for target structure and thermal scanning;
I. Memory means, CPU, operating system containment or housing means;
J. Transceiver; and
K. Monitoring means,
   wherein, when effectively linked together and with the appropriate software means, will be used to scan the target structure and detect a fire therein, for monitoring and fire extinguishment encasement programming.

As used herein, the Fire Nemesis System™ Fourth Generation Smart Building System's containment means should be constructed of a material comprising a material, substance or similar suitable means that is capable of withstanding extreme heat up to 3,000° F., over a continuous period of three (3) or more hours; extreme thermal fluctuations over a prolonged period of three (3) or more hours; a material that is of a self fire extinguishing means; constructed in such a manner and with such material capable of withstanding severe multiple impacts at X^{psi}, (where X^{psi} represents the minimum force of impact that a Black Box Flight Data and Voice Recorder or similar material and means must sustain as used by the commercial airlines industry for voice and data recording system protection); rapid heat dissipating means; and, that will not impede the ability of the System's scanning means to perform its intended scanning functions or impede the transceiver's ability to transmit data to a remote position and receive authorized data from an external or remote authorized means.

As used herein, a platform of the Fire Nemesis System™ Fourth Generation Smart Building System's self-righting means, and of the Fire Nemesis System™ Fourth Generation Smart Building System's scanning means shall be a means whereupon the self-righting means and/or the scanning means may be attached, affixed to, placed upon, secured to, or similarly joined to, within the Fire Nemesis System™ Fourth Generation Smart Building System's housing means.

As used in this invention, a self-righting means shall be a means comprising a device, system, methodology, means, method, action, mechanism or similar means that may be linked to a gyroscopic sensor and control, a global positioning system, Micro Electronic Mechanical System, gimbals or other means to orient the platform to its intended or near intended position, angle, or orientation, for scanning purposes, that in some way, shape or manner when activated by sensors detecting an unintended change in position, axis or orientation, will cause gyroscopic sensor and control, a global positioning system, Micro Electronic Mechanical System or other means to orient the platform to its intended or near intended position, angle, or orientation for scanning purposes.

As used herein, a Fire Nemesis System™ Fourth Generation Smart Fire Suppression System safety means where the Fire Nemesis System™ Fourth Generation Smart Fire Suppression System is under unauthorized circumstances dislodged from and moved beyond the boundaries of its intended fixed position, shall be a means comprising a program, software, system, means, device, method or similar means using GPS readings where possible, Micro Electronic Mechanical device, and altimeter readings, the linked to the system's software, memory and signal transmission means, that will cause an alert to be generated then transmitted to onsite, or to a remote authorized monitoring or receiver means of the Fire Nemesis System™. Said signal shall also include the Fire Nemesis System™ Fourth Generation Smart Fire Suppression System scanning mean's new position relative to its intended fixed position or static position, and that it is no longer operating within its prior intended position (to prevent false readings or an indication that a fire does not exist within the original scanning area, due to the fact that it is no longer within its original position), and further comprising a device, mechanism, means, system, feature, or similar means that will generate or cause to be generated a signal that will serve as an electronic beacon, locator, tracking means, or similar means that will provide an authorized user with the means to detect, track and locate the position of such signal and the system itself.

As used herein, the Fire Nemesis System™ Fourth Generation Smart Fire Suppression Building System's use of micro-impulse radar scanning system, RF, an ultra-wide band system, laser, laser system, optical, acoustical, acoustical system, to perform scanning of a structure and fire zone shall also be a means herein comprising a modification of such systems that are then linked with the appropriate software program to produce:
A. A non-invasive detection;
B. A two-dimension and three-dimensional mapping of the thermal zone of the target structure scanned;
C. Non-invasive detection, and a two-dimension and three-dimensional mapping of the thermal differentiation within and contiguous to the fire zone of the target structure scanned; and
D. A two-dimension and three-dimension mapping of a fire zone.

As used herein, the Fire Nemesis System™ Fourth Generation Smart Fire Suppression Building System's use of micro-impulse radar scanning system, RF, an ultra-wide band system, laser, laser system, optical, acoustical, acoustical system, to perform scanning of a structure and fire zone shall also be a means comprising a system that is further linked to a memory device comprising a processing device which includes a library of known characteristics of high-rise, commercial, residential, industrial, underground transportation infrastructures, its voids, barriers, barrier walls, walls, multiple walls, open spaces, bodies, formations, openings such as doorways, halls, chases, windows, shafts, and other spaces common to such structures, so that when linked with the appropriate object recognition software, the software utilized to produce the two-dimension and three-dimensional mapping of the structure in its pre-fire state will produce a comprehensive two-dimension and three-dimensional mapping of the target structure inclusive of objects therein.

As used herein, the Fire Nemesis System™ Fourth Generation Smart Fire Suppression Building System shall also mean, a means comprising a system that is further linked to a memory device comprising a processing device which includes a library of known characteristics of high-rise, commercial, residential, industrial, underground transportation infrastructures that produced a comprehensive two- and three-dimensional mapping of the target structure inclusive of objects and structures therein, so that when scanning the target structure during or for a fire (as used herein, “active fire”), will compare the active fire scan data against the pre-fire scan data in memory, thereafter producing in real-time a two-dimension and three-dimensional map of the structure and fire zone, including the recognition of objects, presence and position of persons within the structure.

This shall further mean, a means comprising a system comprising a means from which its scan data will be used to produce a two-dimension and three-dimensional mapping of the fire's thermal patterns within the scanned area, in real-time. The data gathered to produce the three-dimensional map of the scanned structure and the fire zone(s) will then be used to program the encasement's smart system to seek out, target and extinguish a fire, with the capacity to direct fire extinguishing material loads to different points of the fire, its trajectory means, its navigation means, discharge control means, and other fire extinguishment encasement components.

This shall also mean, a means comprising a device, mechanism, instrument, or similar means further comprising a micro-impulse radar means, ultra-wide band radar means, laser, acoustical, infra-red, optical or similar device or means that may be linked to or incorporated into the fire extinguishment encasement launching means, with the capacity to scan a structure and fire, or provide target sighting, that is further linked to the appropriate software, software program or means to produce a three-dimension layout of the scanned structure, including its dimensions, openings, barriers, walls, objects, a two-dimension and three-dimension topographical map of the fire, the presence and position of a human subject(s) within or near to the scanned area; that can be used to determine the optimal and alternative patterns to combat a fire applied to programming the fire extinguishment encasement and for training purposes; that may then be linked to a transceiver means that will transmit said data to a Fire Nemesis System™ Smart Fire Extinguishment Encasement programming means and a Fire Nemesis System™ monitoring means, as well as to receive and transmit such data to and from a remote monitoring and encasement programming means.

This shall further mean a means comprising a programmable, software system linked to a memory device or means comprising an encrypted signal, code, restricted spectrum/radio frequency or similar means that will be embedded within all transmission signals broadcast by the Fire Nemesis System™ Fourth Generation Smart Building System to a Smart Fire Extinguishment Encasement programming means, and the Fire Nemesis System™ monitoring means, so that its transmission signal can only be received by a Smart Fire Nemesis System™ equipped to verify the encrypted signal, code, restricted spectrum/radio frequency or similar means, and will only receive a transmission within that designated spectrum or frequency.

This shall further mean a means comprising a programmable, software system linked to a memory device or means comprising encrypted digitized Fire Nemesis System™ (e.g., fingerprint) segment(s) of all authorized operators, so that its transmission signal means can only be received by a Fire Nemesis System™ equipped to verify an authorized operator's encrypted digitized identification segment(s), and where the transceiver can only receive an externally generated signal containing an authorized operator's encrypted digitized identification segment(s).

As used herein, the Fire Nemesis System™ Fourth Generation Smart Fire Suppression Building System's monitoring means shall be a means comprising a structure, means, conveyance, that when activated, turned on, charged, or by similar means programmed, so that data transmitted from the Fire Nemesis System™ Fourth Generation Smart Fire Suppression Building System's scanning means can be received, stored, retrieved and interpreted therefrom.

As used herein, the Fire Nemesis System™ Fourth Generation Smart Fire Suppression Building System's monitoring means, shall also mean a means comprising a structure, means, method, mechanism, or similar process that will alert authorized Fire Nemesis System™ operators to the presence of a fire within the target structure, including the position, evolution of, thermal range, thermal differentiation range of the fire, the presence, location, and movement of persons within the target structure and fire zone: where such information may in turn be transmitted, uploaded to or similarly transferred to the Fire Nemesis System™ Smart Fire Extinguishment Encasement: to its programming means that is remote or onsite respective to the target fire situation: to the fire extinguishment encasement launcher means; or, other Fire Nemesis System™ fire extinguishment encasement storage, programming, and launching means.

As used herein, the Fire Nemesis System™ Fourth Generation Smart Fire Suppression Building System's monitoring means shall further mean, a means comprising a structure, means, method, mechanism, or similar process where such information may be transmitted, uploaded to or similarly transferred to a monitoring means contiguous to the original scan zone, whereupon authorized Fire Suppression Delivery System operators can access same to display two- and three-dimensional scan data of the structure and fire zone; cause same to be transmitted to, uploaded to or similarly transferred to the Fire Nemesis System™ fire extinguishment encasement launcher means or other fire extinguishment encasement storage, programming, and launching means, for the purpose of programming and subsequently launching the Fire Nemesis System™'s Fire Extinguishment Encasement.

As used herein, application of the Fire Nemesis System™ software and memory means shall be a means comprising a system, method, conveyance or similar means that will contain the scan data of the structure and fire.

Upon detection of a fire, data as to presence of the fire relative to the scanning means that when linked to the appropriate software and monitoring means will be compared against the structure scan data contained within its memory to determine the position or multiple positions of the fire within the structure; producing a 2-Dimensional and 3-Dimensional grid or map, reading or similar representation of the structure, the fire, and the fire's thermal range.

Where two or more scanning means are used, software will conform the images from both scanning means in such a manner that an overlap or confusion of images will not be produced

As used herein, the Fire Nemesis System™ Fourth Generation Smart Building Fire Suppression System scanning means' position relative to its original fixed position or pre-fire position shall mean, a position, place, area, track, pedestal, inset, recess, containment means, containment area, mechanism or similar means, to which the Fire Nemesis System™ Fourth Generation Smart Building Fire Suppression System scanning means' can be affixed, positioned upon, positioned within, positioned to, set upon, set on, or similarly affixed to, permanently or temporarily, and from that position the original or last pre-fire or pre-blast-event scan of the structure, shall have been made by the Fire Nemesis Syste™ Fourth Generation Smart Building Fire Suppression System scanning means' to produce the 2-Dimensional and 3-Dimensional grid, map, reading or similar representation of the structure and structural layout, prior to misalignment, dislodging of or unauthorized removal from that fixed physical or static position.

As used herein, the Fire Nemesis System™ Fourth Generation Smart Building Fire Suppression System scanning means' Remote Operation Verification means, shall be a means comprising a system, means, method, mechanism, provision, or similar mechanism that is capable of receiving an externally generated authorized signal that will in turn activate the Remote Operation Verification software program so as to test the scanning means and determine whether or not the system is fully operational.

As used herein, the Fire Nemesis System™ Fourth Generation Smart Building Fire Suppression System scanning means' Remote Operation Self-diagnosis and repair means, shall mean, a means comprising a system, means, method, mechanism, provision, or similar mechanism that is capable of receiving an externally generated authorized signal that will in turn activate the Remote Operation Self-diagnosis software program to provide a diagnostic check of the Fire Nemesis System™ Fourth Generation Smart Building Fire Suppression System scanning means' operational system, whereupon detecting a malfunction will repair same.

In an embodiment, FIG. 22, diagrammed here for illustrative purposes only, where the target structure to be scanned and recorded is a high-rise residential structure. Here, the Fire Nemesis System™ Fourth Generation Smart Building Scanning means (745) is placed at a fixed position in the structure (743), with temporary boundary sensors (744) placed strategically throughout the structure, which when activated will permit the Fire Nemesis System™ Fourth Generation Smart Building Scanning means to measure both the horizontal and vertical boundaries of the structure (742). By emitting a scan pulse from the (749) System's Smart Building Scanning means (745), the return pulse (757) provides data as to the two-dimensional and three-dimensional proportions of the structure (742), and the position of objects found therein. In turn the scan data of the return pulse (757) will be added to the memory means of the Fire Nemesis System™ Fourth Generation Smart Building Scanning means comprising the database, i.e., the layout of the structure. This database will become the comparative upon which subsequent scans and fire alert scans will be measured against, when determining the presence of new objects within the field and the presence of a fire, blast detection, thermal differentiation of the fire, and the presence of any person within or proximate to the fire zone. This data will also become part of the database comprising objects common to this and similar structures, and will provide a reference point as to objects which may be common to this particular structure in the event of a fire.

This scanning capacity of the Fire Nemesis System™'s Smart Building Scanning System, particularly during detection and monitoring of a fire, should be of particular aid to firefighters entering evolved fire structures to know the existence and position of false walls or other barriers constructed after the original construction but not indicated upon an architectural diagram, as well as critical spots such as ducts (762) (where superheated air or fire may emit from), gas or chemical lines.

Where access is feasible for placement of sensors within adjacent structures (751) and common area or passageways (765), or where the material used in the construction of same will permit penetration of the pulse emitted by the Fire Nemesis System™'s Fourth Generation Scanning means through a wall or barrier, as well as active scanning at the time of a fire, which will permit a firefighter to determine the presence and position of fire within the wall structure (768) and the area immediately contiguous to same (751, 765).

In a continued embodiment, FIG. 23 illustrates a cross pattern of initial scanning, where the scanning pulse (749) emitted from the Fire Nemesis System™ Fourth Generation Smart Building Scanning means (745) returns (757) in a linear and cross pattern (745), thereby providing both 2-dimensional and 3-dimensional data of the target structure (742). When construction and material of the objects (759) encountered will not permit through-passage of the pulse (749), the scattered or deflected pulse (761) is picked up by the strategically placed sensor (744), which in turn will be interpreted by the appropriate software of the scanning means (745) to determine the position and dimensions of the structure therein.

In still another embodiment, FIG. 24, where the Fire Nemesis System™'s Fourth Generation Smart Building Scanning means (745) has been dislodged from its fixed position (743) or placed at a different point within the same structure (769), the GPS, MEMS and actuators are used to first re-orient the platform of the scanning means within its housing means. The Fire Nemesis System™ Fourth Generation Smart Building Scanning means emits scanning pulses (770, 771, 772)) to at least three (3) different positions within the target structure, triangulates the return scan data. Using the database containing the original scan data or subsequent pre-fire, pre-dislodgment data, along with the appropriate object recognition software and the new scan data, the Fire Nemesis System™ Fourth Generation Smart Building Scanning System will then determine its new position within the target structure. The Fire Nemesis System™ Fourth Generation Smart Building Scanning means will conform its position or location within the target structure to that of pre-existing data, the original scan data produced for the target structure existed while the Fire Nemesis System™ Fourth Generation Smart Building Scanning System (745) was at its pre-movement position (743). A firefighter (792) entering the stairwell (or other access area) (764) contiguous to the target structure (742) and using the scan data would view the target structure from the firefighter's position (792, 764) relative to the structure (742): i.e., the produced in the new position (769), when using the appropriate software and new scan data, would be conformed in such a manner so that the firefighter entering the area will have a correct orientation of the target structure and the fire relative, to his or her position (792).

In another embodiment FIG. 25, illustrates where the scanning means detects the presence of a fire at Point X. This data will then be compared against the structural layout data contained within the scanning means memory means. Subsequently, the software produces a 2-Dimensional and 3-Dimensional grid/map of the fire zone(s) and the room, including a 2-Dimensional and 3-Dimensional differentiation thermal range grid/map. Here, also, for illustrative purposes, Scanning Means-One (745) detects the presence of a fire at Point X, while Scanning Means-Two (773) detects the presence of a fire at Point Y. The software means for the Fire Nemesis System™ Fourth Generation Smart Building Fire Suppression System compares the data from both scanning means in relationship to the structural layout, producing one cohesive two-dimensional and three-dimensional grid/map of the fire zone, room/target scan area, the thermal range and thermal differentiation of the fire. Based upon structural material, heat, speed, oxygen and other factors, including objects detected within the scan field of the target area, the Fire Nemesis System™ Fourth Generation Smart Building Fire Suppression System can then make a determination as to the likelihood and possible time in which “X” fire and “Y” fire may combine to form a larger conflagration (“Z”). This is not only advantageous to firefighters before entering the target structure but in planning combat strategy, including whether to launch fire suppressants or retardants between fire Points “X” & “Y” to prevent development of the larger “Z” conflagration.

The scan data (774) of the target structure (742) and the fire therein, as generated by the Fire Nemesis System™ Fourth Generation Smart Building Fire Suppression System (742) is transmitted to a remote monitoring means (775), to a secure monitoring means contiguous to the fire situation (767), and to authorized firefighters equipped with the Fire Nemesis System™ comprising the means to receive the restricted (or, “spectrum”) signal. The authorized Fire Nemesis System™ operator has the option of utilizing the scan data and programming information developed by the Fourth Generation Smart Building Fire Suppression System, scan data generated by use of the Fire Nemesis System™ Third Generation (launcher and other means), remote programming data, or manually program the fire extinguishment encasement for deployment to the fire situation.

### 6. The Fire Nemesis Systems Fifth Generation Fire Suppression Delivery System

As used herein, the Fire Nemesis System™ Fifth Generation system shall mean a Fire Suppression Delivery System comprising an adaptation of the System for application against fires within (but not limited to large) marine vessels, in particular to (and again) but not limited to military and commercial marine vessels containing personnel accessible compartments or areas.

As also used herein, the Fire Nemesis System™ Fifth Generation Sentinel Smart Fire Extinguishment Encasement shall be, a means comprising Smart Fire Extinguishment Encasement, further comprising:

A. A thermal scanning means;

B. A Structural scanning means;

C. A transceiver;

D. CPU, memory means;

that when activated and projected into a compartment where a fire is suspected or known to exist, will cause the structural and thermal scanning means to emit scanning pulses to determine the position of the fire within the compartment, the fire's topography, the boundaries of the compartment and position of the Fire Nemesis System™ fire extinguishment encasement relative to same, and cause such to be transmitted to the onsite and/or remote (encasement) programming means for Smart Fire Extinguishment Encasements to be or subsequently programmed and projected into the fire situation.

As further used herein, a Fire Nemesis System™ Fifth Generation Fire Suppression Delivery System shall also be a means comprising a Fire Nemesis System™ Smart Fire Extinguishment Encasement, further comprising a:
A. A third activatable means;
B. An electronic beacon/locator means;
C. Gyroscopic sensor(s);
D. Obstruction detection and avoidance means;
E. A database also comprising the basic dimensions of each compartment, so that when the Fire Nemesis System™ Sentinel Smart Fire Extinguishment Encasement is activated, its launch data will include the compartment specific identifiers and data;
F. Activatable magnet surface area; and
G. The option of a fire extinguishment containment area,
   that when activated subsequent to discharge from its launching means, will cause the magnetic surface area of the Fire Nemesis System™ Smart Fire Extinguishment Encasement to become charged proximate to or within the target compartment, so that working in conjunction with the trajectory and navigation controls will cause the magnetic surface to adhere to the metallic surface within the target compartment, as programmed to the trajectory.

As used herein, a target compartment shall mean the compartment, area, room or similar structure or area within a marine commercial or military vessel, watercraft or platform, where a fire situation is or can occur, and in this instance where a fire is known or suspected to exist, from which the Fire Nemesis System™ Sentinel Smart Fire Extinguishment Encasement and/or Smart Fire Extinguishment Encasement database that contains the interior structural dimensions of each compartment therein shall contain an appropriate link to a unique identifier assigned to each said compartment, so that when manually or electronically entered to and by the Fire Nemesis System™ Sentinel Smart Fire Extinguishment Encasement or the Smart Fire Extinguishment Encasement programming means will appropriately upload, insert or similarly incorporate the compartment specific database information into the Fire Nemesis System™ Sentinel Smart Fire Extinguishment Encasement/Smart Fire Extinguishment Encasement operating system, trajectory and navigation, search, targeting, and fire extinguishment load discharge sequence(s).

As again used herein, the Fire Nemesis System™ Fifth Generation Fire Suppression Delivery System shall further mean, a primary Fire Nemesis System™ Encasement comprising multiple Fire Nemesis System™ Sentinel Smart Fire Extinguishment Encasements, so that when the primary Fire Nemesis System™ Sentinel Smart Fire Extinguishment Encasement is projected into the target compartment and when activated, will cause each of the individual Fire Nemesis System™ Sentinel Smart Fire Extinguishment Encasements to separate from the primary Fire Nemesis System™ Smart Fire Extinguishment Encasement body and independently attach to different points or areas within the target compartment, as programmed. In turn scan the fire and its thermal topography, determine its position within the target compartment that can determine the position and location of other Sentinel Smart Fire Extinguishment Encasements and Smart Fire Extinguishment Encasements in the compartment, and cause such data to be transmitted to the Fire Nemesis System™ Smart Fire Extinguishment Encasement onsite or remote monitoring and its programming means.

As yet again used herein, a Fire Nemesis System™ Fifth Generation Smart Fire Extinguishment Encasement shall be a Fire Nemesis System™ Smart Fire Extinguishment Encasement further comprising:
A. An activatable means;
B. Gyroscopic sensors, Micro Electronic
Mechanical Systems, actuators, altimeter(s);
C. Memory means;
D. Obstruction detection and avoidance means, linked to the appropriate targeting software and control means;
E. An object recognition software means comprising data specific to the target compartment, linked to the appropriate memory means, further comprising a library of objects common to a military or commercial marine vessel and its compartment structural layout;
F. A second activatable means;
G. An activatable magnetic surface;
H. A database of also comprising the basic dimensions of each compartment, so that when the Fire Nemesis System™ Sentinel Smart Fire Extinguishment Encasement is activated, its launch data will include the compartment specific identifiers and data,
   that when programmed by the Fire Nemesis System™ Smart Fire Extinguishment Encasement programming means, which will include the database comprising the dimensions of each compartment, (and where utilized the programming data from the Fire Nemesis System™ Sentinel Smart Fire Extinguishment Encasement[s]), then projected into the target compartment, will navigate the compartment based upon the programmed trajectory linked to the appropriate obstruction detection and avoidance means, object recognition software and database (comprising data specific to and the target compartment) identifier, and:
A. Search for and target the fire, as programmed; or
B. Will initiate the second activatable means controlling the magnet surface, wherein the Fire Nemesis System™ Smart Fire Extinguishment Encasement will attached itself to a metallic surface within the target compartment as programmed, then discharge its fire extinguishment load as programmed, independently or simultaneous to or in tandem with that of other Fire Nemesis System™ Smart Fire Extinguishment Encasements so projected to the target compartment, thereby effecting individual, canopy or blanket coverage of the fire situation therein.

In an embodiment, FIG. 26 illustrates a partial panel cross-section of the Fire Nemesis System™ Fifth Generation Marine Vessel Containment system (776), where the exterior area is constructed of blast proof material construction (777), the center area is constructed of blast attenuating material (778), and the interior surface area constructed with high quality insulation (779). The door(s) or panel(s) (789) which when opened will permit launching of the Fire Nemesis System™ Sentinel Smart Fire Extinguishment Encasements and Smart Fire Extinguishment Encasements contained therein to the compartment and fire environment, can slide into the walls of the containment means, or fold outward to the compartment.

In an embodiment, FIG. 27 illustrates a Smart Fire Extinguishment Encasement modified to serve as a Sentinel Smart Fire Extinguishment Encasement (780). One or more exterior surface areas (781) are constructed to facilitate attachment of the encasement to a metallic surface within the target compartment. The Fire Nemesis System™ Sentinel Smart Fire Extinguishment Encasement contains an activatable surface area (781) that can be magnetized, by initiation of the activatable means (784) subsequent to discharge of the encasement from a launching means to the target compartment. The Fire Nemesis System™ Sentinel Smart Fire Extinguishment Encasement also contains a structural scanning means (786) linked to an appropriate CPU (782) and memory (783) means comprising a database of the compartment's dimensions, object recognition software, and objects common to commercial and military vessels. The Fire Nemesis System™ Smart Fire Extinguishment Encasement also comprises a thermal scanning means (786-A), unless the structural scanning and the thermal scanning are performed by a single scanning means. The scan data generated by the Fire Nemesis System™ Sentinel Smart Fire Extinguishment Encasement is either:
A. Processed by the CPU (782) and appropriate software to produce a two-dimension and three-dimension programming format, then transmitted to a Fire Nemesis System™ Smart Fire Extinguishment Encasement's programming means; or
B. It is sent by the transceiver (787) to an onboard Fire Nemesis System™ Smart Fire Extinguishment Encasement programming means.
   The fire extinguishment encasement's transceiver (787) here comprises the electronic beacon (785). The electronic beacon (785) individually identifies each Fire Nemesis System™ Sentinel Smart Fire Extinguishment Encasement and Smart Fire Extinguishment Encasement. Unless a Fire Nemesis System™ Smart Fire Extinguishment Encasement is programmed to attack the same position as a predecessor Fire Nemesis System™ Sentinel Smart Fire Extinguishment Encasement or Smart Fire Extinguishment Encasement, the electronic beacon is utilized by each fire extinguishment encasement to track other Fire Nemesis System™ fire extinguishment encasements, to prevent subsequent Smart Fire Extinguishment Encasements from attacking or attaching to the same point as its predecessor, particularly where the targeting and discharge pattern of two or more Fire Nemesis System™ Smart Fire Extinguishment Encasements includes targeting the fire at Point X, but at a (minimum or maximum) distance and height from Point Y, where Point Y represents the location of a Fire Nemesis System™ Sentinel Smart Fire Extinguishment Encasement or Smart Fire Extinguishment Encasement in the projection field.

As used herein, the Fire Nemesis System™ hand held fire extinguishment encasement launcher means shall be modified, comprising a device, conveyance, mechanism or similar means, that will electronically, visually, audibly or tactilely alert an authorized Fire Nemesis System™ operator in actual control of the launching means as to the compartment the operator (with the launcher) is within, is approaching, and/or has directed the target locator means to or towards.

As used herein, a Fire Nemesis System™'s Fifth Generation containment means, shall be a means comprising:
A. An encasement means, constructed in such a manner further comprising:
   i. A blast-proof material;
   ii. A blast attenuating material;
   iii. A self-fire extinguishing material,
      wherein, by constructing it in such a manner where the exterior of the Fire Nemesis System™'s Fifth Generation containment means will withstand a blast of X^{psi}, where X^{psi} is the maximum force that can be exerted upon, within, or against the compartment of a marine commercial or military vessel (whichever is greater), without destroying the compartment (wall, ceiling, floor, and support) therein; that will also withstand continued exposure to sustained temperatures of 3,000° F. for a period of three (3) hours or longer; and, a self fire extinguishing composition, so that debris created by a fire or blast within the target compartment will not penetrate, lodge within or prevent operation of the Fire Nemesis System™ Fire Suppression Delivery System. Here, the interior surface area of the Nemesis System™'s Fifth Generation Fire containment means comprises a blast attenuating or limiting material and construction to prevent the percussion force generated by a blast from adversely impacting upon the interior compartment area of the Fire Nemesis System™ Fifth Generation Fire Suppression Delivery System and the components contained therein. Subsequently, high quality insulation is affixed to or integrated to the interior compartment of the Fire Nemesis System™'s Fifth Generation containment means, to prevent excess or latent heat from the blast and/or fire situation from entering the containment area while the latter's position doors, access panels, or similar structures are closed; and, to dissipate heat away from the interior of the containment area and components therein when exposed to the fire environment when the doors are opened to project the Fire Nemesis System™ Sentinel Smart Fire Extinguishment Encasement and/or Smart Fire Extinguishment Encasement to the fire situation.

As used herein, a Fire Nemesis System™'s Fifth Generation containment means, shall also be a means comprising:
A. A sensor means that when linked to the appropriate software means, door control means, Fire Nemesis System™ Sentinel Smart Fire Extinguishment Encasement and Smart Fire Extinguishment Encasement projection means, will determine whether the area between the containment means' doors, access panels, or similar structure(s) leading to the exterior environment, has sufficient clearance to permit successful projection of an encasement contained therein, to the fire situation within the target compartment;
B. A structural scanning means, and a thermal scanning means, linked to the appropriate software means to produce a two-dimensional and three-dimensional map and thermal grid of the fire or blast area from within the target structure;
C. Object recognition software;
D. Database of objects common to the target compartment, and to marine commercial and military vessels or platforms;
E. Fire Nemesis System™ Sentinel Smart Fire Extinguishment Encasement and Smart Fire Extinguishment Encasement programming and projection software and control means;
F. A means to attach and secure the Fire Nemesis System™ Sentinel Smart Fire Extinguishment Encasements and Smart Fire Extinguishment Encasements within the Fire Nemesis System™'s Fifth Generation containment means;
G. Secondary, independent, or alternate power resource means;
H. Transceiver;
I. Remote diagnostic and repair means; and
J. Activatable means,
   wherein, the activatable means of the Fire Nemesis System™'s Fifth Generation Marine Vehicle Containment means when linked to the appropriate software means and actuators, is initiated by detection and presence of a fire or blast within the target compartment; Fire Nemesis System™'s verification of door function and sensor(s) determination that sufficient clearance exists for proper launch of Fire Nemesis System™ Sentinel Smart Fire Extinguishment Encasements and Smart Fire Extinguishment Encasements contained therein, and working in conjunction with closing of the target compartment's bulkhead door to which the Fire Nemesis System™'s Fifth Generation containment means is attached. The data produced by the structural and thermal scanning means, when processed by the appropriate software means is linked to the database of objects common to the target compartment, marine commercial and military vessels or platforms, object recognition software, and utilized by the Fire Nemesis System™ Sentinel Smart Fire Extinguishment Encasement and Smart Fire Extinguishment Encasement programming and projection software and control means, so that the optimal fire combat pattern, its trajectory and navigation, and discharge sequences respectively (unless overridden for remote or manual programming), will be programmed into the Fire Nemesis System™ Sentinel Smart Fire Extinguishment Encasement and Smart Fire Extinguishment Encasement, which will then be discharged to the fire environment.

In another embodiment, FIG. 28 illustrates a Fire Nemesis System™ Smart Fire Extinguishment Encasement with the activatable magnetic surface area (781) that is magnetized by the activatable means (784). Here, as with the Fire Nemesis System™ Sentinel Smart Fire Extinguishment Encasement, activation of this surface area will facilitate optional programmed attachment of the encasement to a metallic surface within the target compartment: which is determined at the time the Fire Nemesis System™ Smart Fire Extinguishment Encasement is programmed. The structural and scanning means (786) linked to the CPU (782) and memory means (783), working in conjunction with the appropriate trajectory and navigation means, targeting and discharge control means, object recognition software, obstruction detection and avoidance means, and a database comprising the dimensions of the compartment, will permit programming the Fire Nemesis System™ Smart Fire Extinguishment Encasement to discharge its fire extinguishment load:
A. Directly within the fire; or
B. In mid-flight; and/or
C. By first strategically attaching the encasement to a metallic surface within or proximate to the fire, within the discharge field of the encasement.
   Here, however, where the Fire Nemesis System™ Sentinel Smart Fire Extinguishment Encasement's structural scanning means and thermal scanning means is designed to determine the boundaries of the target structure relative to the fire and to produce a two-dimensional and three-dimensional grid or map of the area, the thermal scanning means (789) of the Fire Nemesis System™ Smart Fire Extinguishment Encasement is its heat seeking head with thermal differentiation function.

Here, also, the Fire Nemesis System™ Smart Fire Extinguishment Encasement's structural scanning means (790) compares the programmed trajectory and navigation data against landmark objects or coordinates previously made a part of the database, to effect precision navigation and discharge. As noted in this embodiment (FIG. 26), the Fire Nemesis System™ Smart Fire Extinguishment Encasement is fitted with more than one activatable magnetic surface area (781).

As also used herein, the Fire Nemesis System™'s Fifth Generation Smart Fire Extinguishment Encasement can be developed for chafe discharge where the option to attach the encasement to a metallic surface area within the target compartment is programmed into its trajectory, navigation, and discharge program. As well, the activatable magnetic surface can be intentionally demagnetized, subsequent to attachment to a metallic surface within the target compartment, allowing the encasement to drop into or near the fire zone, and to discharge its fire extinguishment load accordingly.

Where the bulkhead door is not closed, the sensor for the Fire Nemesis System™'s Fifth Generation containment means affixed to the target compartment interior side of the bulkhead door will determine whether sufficient clearance exists for successful projection of the encasements contained therein. Where such sensors determine sufficient space exists, and operating in conjunction with the data produced by the structural and thermal scanning means that is processed by the appropriate software means linked to the database of objects common to the target compartment, marine commercial and military vessels or platforms, object recognition software and encasement programming and projection software and control means, wherein, the Fire Nemesis System™'s tactical software program will determine the optimal fire combat pattern that will be programmed into the Fire Nemesis System™ Sentinel Smart Fire Extinguishment Encasement and/or Smart Fire Extinguishment Encasement, for deployment to the fire environment.

Where the target compartment interior side of the bulkhead door is not closed, but the structural scanning means and the thermal scanning means of the Fifth Generation Fire Nemesis System™ containment means is unable to determine the position and magnitude of the fire within the target compartment, and where programming and launch data is not provided remotely, it will:
A. Project a Fire Nemesis System™ Sentinel Smart
Fire Extinguishment Encasement to a predetermined position within the target structure, that will in turn transmit scan data for Fire Nemesis System™ Smart Fire Extinguishment Encasement programming; and/or
B. Program the Fire Nemesis System™ Smart Fire Extinguishment Encasements contained therein for navigation within the target structure, based upon the data of the target compartment's structural dimensions, the database of objects common to the target compartment, marine commercial and military vessels or platforms, while also programming it to perform a thermal or heat seeking search within the target compartment, then launched to the fire environment accordingly.

Where the bulkhead door is not closed and clearance sensors indicate insufficient clearance for successful launch of an encasement to the target compartment, its sensors will cause activation of the exterior side bulkhead door mounted Fifth Generation Fire Suppression Delivery System, which will:
A. Project a Fire Nemesis System™ Sentinel Smart Fire Extinguishment Encasement to a predetermined position within the target structure, that will in turn transmit scan data for Smart Fire Extinguishment Encasement programming; and/or
B. Program the Fire Nemesis System™ Smart Fire Extinguishment Encasements contained within for navigation within the target structure based upon the data of the target compartment's structural dimensions, the database of objects common to the target compartment, marine commercial and military vessels or platforms, while also programming it to perform a thermal or heat seeking search within the target compartment, then launched accordingly.

As used herein, the Fire Nemesis System™'s Fifth Generation Fire Suppression Delivery System shall also mean, a System that can be affixed to the ceiling, wall, or other structure within the compartment, that is remotely, manually, or electronically activated by detection or presence of a fire and/or blast within the target compartment; that upon such activation shall cause the structural scanning means and the thermal scanning means to emit scanning pulses to determine the position of the fire within the compartment, the fire's topography; or, launch a Fire Nemesis System™ Sentinel Smart Fire Extinguishment Encasement into the target compartment for the same purpose. Which ever scanning means is used, the data from same will be transmitted to onsite or remote Fire Nemesis System™ Smart Fire Extinguishment Encasement programming means for Smart Fire Extinguishment Encasements that will be projected into the fire situation.

### REFERENCES CITED

| | | |
|---|---|---|
| 6,089,324 | Mahrt, David M. | Jul. 18, 2000 |
| 6,109,359 | Ballard, Paul C. | Aug. 29, 2000 |
| 6,276,459 | Herrick, et al. | Aug. 21, 2001 |
| 6,298,658 | Bak, Michael J. | Oct. 9, 2001 |
| 6,328,225 | Crampton, George | Dec. 11, 2001 |
| 6,382,559 | Sutterfield, et al. | May 7, 2002 |
| 6,474,593 | Lipeles, et al. | Nov. 5, 2002 |
| 6,507,023 | Parham, et al. | Jan. 14, 2003 |
| 6,612,217 | Shockey, et al. | Sep. 2, 2003 |
| 6,675,297 | Ignaszewski, Michael | Jan. 6, 2004 |
| 6,694,435 | Kiddy, Raymond R. | Feb. 17, 2004 |
| 6,722,611 | Wu, et al. | Apr. 2, 2004 |
| 6,779,114 | Chow, et al. | Aug. 17, 2004 |
| 6,819,237 | Wilson, et al. | Nov. 16, 2004 |
| 6,854,688 | McElroy, et al. | Feb. 15, 2005 |
| 6,866,733 | Denham, et al. | Mar. 15, 2005 |
| 6,873,256 | Lemelson, et al. | Mar. 29, 2005 |
| 6,938,408 | Lair, Jean-Pierre | Sep. 6, 2005 |
| 20030037665 | Rupert, et al. | Feb. 27, 2003 |

1-20. (canceled)

21. A method to prevent unauthorized access of encrypted and non-encrypted data, software, software controlled or electronic means of the Fire Suppression Delivery System, further comprising:
A. Active monitoring of the software and software related means to detect an unauthorized attempt to gain access to such systems of the Fire Suppression Delivery System, and that upon detection of an unauthorized attempt to gain access will activate the means to prevent the unauthorized access attempt (referred to as the “primary level means”);
B. Multiple, independently operating monitoring means to prevent unauthorized access (referred to as the “primary level means”), that is activated upon detection that the activatable monitoring means has failed to prevent such access, that will activate one or more of the multiple, independent activatable means to irreversibly convert the binary code to positive or negative, but not both; and
C. An activatable means, so that
when the primary level monitoring means detects an unauthorized attempt to access, it will activate the software means to prevent any such attempt to reverse engineer, copy, download, access, analyze, obfuscate, deconstruct, upload to, intercept, decompile, tamper with, or interfere with or similar activities. Here, each independent software controlled system of the Fire Suppression Delivery System is monitored by its own, self-contained software security monitoring and unauthorized access prevention means. Upon detection of the failure of the primary level activatable means to initially detect and/or prevent an unauthorized attempt to access the encrypted and non-encrypted data, software, software source code, electronic means or the programming means of the Fire Suppression Delivery System, any of the multiple, independently operating activatable monitoring means that detects such will activate the second level activatable means associated with the independent operating monitoring means: to upload to and insert to the software means of the intruding system a software code, sequence or similar means that will prevent the intended function of the intruding systems' software, software source code, and operating system. This will then cause activation of an activatable means that will cause the source code, software code, sequence or similar means uploaded to the intruding system's operating system(s) to irreversibly convert to positive or negative, but not both, so as to prevent any attempt of the intruder to reverse engineer, copy, download, access, analyze, obfuscate, deconstruct, upload to, intercept, decompile, tamper with, or interfere with or similar activities of the activatable means.

22. A Fire Suppression Delivery System structural and thermal scanning system containment means adapted for a marine containment means comprising:
A. A containment means;
B. An activatable means;
C. A platform or similar means for attachment of the scanning means, Inertial Movement Units (herein, “IMUs”) or similar means, Micro Electronic Mechanical System means (herein, “MEMS”), gimbals, also comprising gyroscopic and other movement control and sensor means;
D. Structural scanning means and thermal scanning means, such as, but not limited to, micro-impulse, laser, infra-red, optical, acoustic or similar scanning means, further comprising:
i CPU and memory means comprising a database of the dimensions of each compartment of a marine vessel that it is installed to, including the dimensions of the compartment(s) contiguous to the bulkhead door to which the containment means will house, program, and launch fire extinguishment encasements from;
ii Structural scanning means and thermal scanning means, linked to the fire extinguishment encasement programming means;
E. An electronic/software and component self-diagnostic means; and
F. An alternate power source,
wherein, the platform, MEMS, IMUs, and movement control means, when linked to the appropriate software and control means will control the movement, pitch, axis control and correction, orientation, angle, rotation, sweep of the System's scanning means. When the controlling activation means of the structural and thermal scanning means is activated, along with the database of the dimensions of each compartment of a marine vessel that it is installed to, the System will determine the existence, position and magnitude of the fire therein for subsequent programming of the fire extinguishment encasements linked to same. Working in conjunction with the software programming means, software security means, CPU, and data memory means, the scanning means will emit a scanning pulse, beam, or signal from within the housing and containment means to the environment of the target scan area. The return signal, when processed by the appropriate object recognition software means, comprising a library of objects commonly associated with marine vessels or other fire situations the Fire Suppression Delivery System is designed to combat, will produce a two-dimension and three-dimension map or grid, including a thermal differentiation map of the fire zone. When the scan data is uploaded to the transceiver, along with an encrypted security access limitation code or limited spectrum frequency, the transceiver will transmit same to a remote and onsite Fire Suppression Delivery System monitoring/programming means, which will permit real-time monitoring of the target structure and fire zone for fire extinguishment encasement programming for fire combat purposes, subsequent fire prevention and tactical fire combat training and investigation. The System will switch to the alternate power source upon detection of a power surge or loss.

23. Fire Suppression Delivery System Structural and Thermal Scanning Containment means of claim 22, further comprising:
A. A material construction of blast attenuating material, and/or self-fire extinguishing material, and/or high quality insulation, and/or an impact limiting material, and/or a high impact resistant material, and/or a heat resistant material, and/or a heat dissipating material;
B. A sensor and sensor activatable means linked to the door(s) and door control means;
C. A means to affix same to the interior surface of a compartment door or bulkhead, to the exterior surface of a compartment door or bulkhead, and/or to the ceiling, wall or other structure of a compartment, common way or area, chase or similar structure,
D. A means to physically affix or contain Fire Suppression Delivery System fire extinguishment encasements within the containment means;
E. MEMS, actuators; and
F. Transceiver,
wherein, when used to house the Fire Suppression Delivery System, construction of the containment means with a blast attenuating material, and/or a high quality insulation, and/or a self fire-extinguishing material, and/or an impact limiting material, and/or a high impact resistant material, and/or a heat resistant material, and/or a heat dissipating material, such is intended to shield the System and its components therein from the effects of fire or blast, and constructed so as to withstand exposure to extreme heat up to 3,000° F. over a continuous period of time; that will dissipate heat away from the interior of the containment area, further comprising a self fire-extinguishing composition. By affixing a Fire Suppression Delivery System Structural and Thermal Scanning Containment means to both exterior surfaces of a compartment's door(s) or bulkhead door(s), so that when the bulkhead/door is closed in response to or detects a fire or blast, the software linked activatable means of the structural and thermal scanning means is activated. Activation of the software linked activatable means of the fire extinguishment encasement's programming means will incorporate the scan data of the compartment and fire or blast area therein, which is incorporated by its tactical programming software to set the navigation, search, trajectory, discharge and other features of the fire extinguishment encasement, prior to discharge of an encasement from within the containment means to the fire/environment. Wherein, when activated, the software linked activatable means of the containment door's micro electronic mechanical means and actuators will open the doors of the containment means to permit launch of the fire extinguishment encasements contained therein, upon activation of the software linked control means to discharge the fire extinguishment encasement. When activated, the transceiver will transmit the System's activity data to the monitoring means.

24. A Fire Suppression Delivery System structural and thermal scanning system containment means of claim 22, further comprising:
A. An activatable means; and
B. An electronic, visual, audible, tactile or similar readable means, bar code, tag, electronic tag or any similar means that will serve as a compartment, room or similar area identifier compatible with and can be detected by, scanned, read by an optical, acoustic, infra-red or similar targeting or target locator readable means of the Fire Suppression Delivery System handheld launcher or other means and systems,
wherein, when the compartment identifier tag is activated by an optical, acoustic, infra-red or similar targeting or target locator reading means it will alert the launcher user as to the specific compartment, room or similar area identified, its position within the marine vessel or structure, wherein such location data can be incorporated into the Fire Suppression Delivery System fire extinguishment encasement's and software programming means.

25. A containment means of claim 22, further comprising:
A. An altimeter or similar means;
B. A transceiver;
C. MEMS, gyroscopic sensor and control, a self-righting means affixed to the platform means and/or to the scanning means;
D. Software, software programming means, CPU and memory means;
E. Activatable means,
wherein upon activation, where the housing means sustains an unauthorized or unintended change in position or orientation, or is otherwise dislodged or removed, or the axis setting is disrupted without correction, it will activate and cause to be broadcast to the Fire Suppression Delivery System's remote and onsite monitoring means the status of change in axis, orientation, and position. An activatable means, when linked to the appropriate software means and the memory means will cause the scanning means to emit scanning signals to at least three (3) or more divergent angles within the structure and its scan path. The return scan data is then interpreted so that when analyzed by the appropriate software means, will then determine the new position of the System's housing and scanning relative to the scanned target area and prior scan data. The new point of orientation, along with an alert will be transmitted to the System's remote and onsite monitoring means. When taken in conjunction with the self-correcting software, MEMS, IMU, altimeter and monitoring or similar means will adjust the platform to or toward the optimal axis position for continued scanning, based upon the new point of orientation, then correct or conform the structural and thermal scan data to the new position. The operator can modify and control the scan sweep pattern of the scanning means in real-time for further observation of the target scan area and the fire zone.

26. A containment means of claim 23, modified for application upon landbased and other structures, further comprising data library of objects commonly associated with the target structures, and software.

27. A containment and scanning means of claim 22, further comprising:
A. An activatable means;
B. Designated spectrum frequency; and
C. Software and memory means software security means further comprising an authorized operator access means;
D. Intrusion and tamper detection and alarm means,
wherein, when the activatable means is activated data to be transmitted, uploaded to, inserted, incorporated to the scan a software program, code, sequence or designated (restricted) spectrum (frequency) that will limit the ability of any means other than an authorized limited access means and operator to receive, intercept, access, execute, copy, modify, retransmit, store or otherwise utilize the transmitted scan data, and causing such to be transmitted to authorized Fire Suppression Delivery System monitoring means and its encasement programming means. A tamper detection and alarm means that when linked to the appropriate software means, will cause the transceiver to transmit an alarm to the Fire Suppression Delivery System remote monitoring means when an unauthorized access to the System is attempted. A breach of the containment means will result in triggering the Fire Suppression Delivery System software safety means.

28. A Fire Suppression Delivery System Smart Fire Extinguishment Encasement, further comprising:
A. An activatable means;
B. A projectile airbrake; and
C. Actuators, IMUs and MEMS,
wherein, when the activatable means that is linked to the software means controlling the Fire Suppression Delivery System Fire Extinguishment Encasement's trajectory and navigation means, that is also linked to its discharge means, is activated, the actuators and MEMS will extend the projectile airbrake means or device housed at or below the exterior of the encasement that comprises the device, from or through, and above the encasement's exterior wall, to the external environment: to the degree and angle programmed by its software controlling means, which can also retract, partially retract, change the pitch and angle of orientation of the device, so as to increase drag upon the encasement to bring about the required orientation, pathway, turn, maneuver, reduced speed or similar action.

29. Fire Suppression Delivery System Smart Fire Extinguishment Encasement of claim 28, further comprising:
A. MEMS and actuators;
B. Activatable means;
C. Hydraulic with a ram surface, or compression means;
D. Compressed powder, granular or similar fire extinguishment material; and
E. Rotating bore surface,
wherein, when the activatable means controlling the MEMS and actuators to the rotating bore surface within the fire extinguishment material containment area is activated, along with the hydraulic means with a ram surface to push same into the fire extinguishment material, or a compression means that will force the fire extinguishment material into the bore surface, the latter will grind against and reduce the compresses fire extinguishment material to a size suitable for discharge from through the fire extinguishment encasement's ejection means.

30. Fire Suppression Delivery System Smart Fire Extinguishment Encasement of claim 28, further comprising:
A. An activatable means;
B. Fluid containment means, foam material source containment means, pressurized gas containment means, separation barrier, fluid and foam material mixing means;
C. Mini or micro pump;
D. Pressurized air/gas generation means; and
E. Pressure sensor(s),
wherein, upon activation of the activatable means linked to the Fire Suppression Delivery System Smart Fire Extinguishment Encasement's navigation and trajectory means, targeting means, and discharge control means, the separation barrier that separates the foam formation material from its fluid mixing medium will collapse to facilitate mixing of the foam material source and the fluid medium, for foam formation. Activation of the software linked activatable means will result in pressurization of the encasement and its contents by the micro pump. The micro pump will assist to eject a high speed stream of air or gas into the mixed foam formation materials, to accelerate and significantly increase the foam creation ratio ejected to the environment through the nozzle or ports. The software control program is linked to pressure sensors within the encasement to prevent over pressurization.

31. A Fire Suppression Delivery System Smart Fire Extinguishment Encasement of claim 28, modified for application upon marine vessels, further comprising:
A. An activatable means;
B. Structural and thermal scanning means;
C. CPU, memory means, a database of the dimensions of each compartment of the specific marine vessel that it is installed to, so that when activated and discharged to the target compartment structure the Encasement will contain such data that will become part of the trajectory and navigation, search, and discharge parameters programmed to the fire extinguishment encasement;
D. Transceiver;
E. Actuators, MEMS, altimeter(s), trajectory and navigation means, search means, targeting and discharge control means, gyroscopic sensor and orientation control means, electronic beacon, collision detection and avoidance means, and obstruction detection and avoidance control means linked to the appropriate targeting software means; and
F. Object recognition software means, and library of objects and structural data common to marine vessels,
wherein, the Fire Suppression Delivery System Smart Fire Extinguishment Encasement is further modified for marine vessel operation. When the software linked activatable means that controls the thermal and structural scanning means, the CPU and memory means, the database, the gyroscopic sensors and orientation control means, the MEMS actuators, altimeter controls, the obstruction detection and avoidance software means, collision detection and avoidance means and the object recognition software means is activated, the Smart Fire Extinguishment Encasement can scan, navigate to, target the fire and respond to the special needs and difficulties associated with combating a fire onboard a marine vessel, particularly below deck and compartment fires.

32. Fire Suppression Delivery System Smart Fire Extinguishment Encasement of claim 28, further comprising:
A. An activatable means; and
B. An activatable magnetic surface,
wherein, when the software linked activatable means that controls the means to magnetize the modified smart fire extinguishment encasement's magnetic surface is activated, it will facilitate attachment of the encasement to a metallic surface within the target compartment/area to, providing a stable platform and position from which the encasement's scanning and discharge means can perform its functions.

33. A Fire Suppression Delivery System Smart Fire Extinguishment Encasement of claim 28, modified to serve as a Sentinel fire extinguishment encasement, further comprising:
A. An activatable means;
B. Structural and thermal scanning means;
C. CPU, memory means, a database of the dimensions of the compartment of the specific marine vessel that it is installed to, object recognition software means, and library of objects and structural data common to commercial and military marine vessels;
D. Transceiver;
E. Actuators, MEMS, IMUs, altimeter(s), trajectory and navigation means, search means, targeting and discharge control means, gyroscopic sensor and orientation control means, electronic beacon, collision detection and avoidance means, and obstruction detection and avoidance control means linked to the appropriate targeting software means; and
F. An activatable magnetic surface,
wherein, the Fire Suppression Delivery System Smart Fire Extinguishment Encasement is further modified, where the software linked activatable means that controls the thermal and structural scanning means, the CPU and memory means, the database, the gyroscopic sensors and orientation control means, the MEMS, IMUs, actuators, altimeter controls, the obstruction detection and avoidance software means, collision detection and avoidance means, and the object recognition software means are activated and the encasement is launched to or within the vessel/compartment, it will perform the structural and thermal scan the area to determine to produce a two-dimension and three-dimension map of the fire zone, the position of same relative to the structure/compartment and obstructions therein. This data will be transmitted to the Fire Suppression Delivery System's fire extinguishment encasement programming means. By activation of the magnetic surface, the Fire Suppression Delivery System Sentinel Smart Fire Extinguishment Encasement can attach itself to a surface area within or contiguous to the compartment area, perform its scanning functions, and where also equipped with fire extinguishment material can discharge its load to the (fire) environment as programmed. Activation of the beacon/transceiver will permit real time determination of the Sentinel Smart Fire Extinguishment Encasement's position using the Sentinel's (transponder) signal for tracking purposes to the containment means and within the compartment, as well as for targeting, collision detection and avoidance of other encasements discharged to the area.
